(19) United States
(12) Patent Application Publication
(10) Pub. No.: US 2026/0312703 A1
(43) Pub. Date: Oct. 8, 2026

(54) Techniques for Passive Intermodulation Avoidance

(71) Applicant: Telefonaktiebolaget LM Ericsson (publ), Stockholm (SE)

(72) Inventor: Torbjörn Wigren, Uppsala (SE)

(21) Appl. No.: 19/480,200

(22) PCT Filed: Jun. 22, 2023
(86) PCT No.: PCT/SE2023/050648

§ 371 Date: Oct. 30, 2025

(51) Int. Cl. H04B 17/345; H04B 1/10; H04W 52/18

(52) U.S. Cl. CPC H04B 17/345; H04B 1/10; H04W 52/18

(57) ABSTRACT

There is provided techniques for PIM avoidance. A method is performed by a nonlinear controller. A method comprises determining, based on presence of uplink PIM, to which fraction of total transmission resources within a transmission slot a set of transmission power reduction factors is to be applied. The method comprises applying the set of transmission power reduction factors to the determined fraction of total transmission resources as distributed over a set of DL transmission carriers within the transmission slot during transmission of a set of signals in the set of DL transmission carriers.

### TECHNICAL FIELD

Embodiments presented herein relate to a method, a nonlinear controller, a computer program, and a computer program product for passive intermodulation (PIM) avoidance.

### BACKGROUND

In general terms, PIM is caused by passive objects, such as filters, duplexers, connectors, antennas and so forth, exhibiting nonlinear behavior in the vicinity of radio signals. PIM can cause an interference signal to be generated that can couple into a receiver and degrade the receiver's sensitivity.

Depending on the location of the component that generates the PIM, the PIM is categorized as either internal or external. For example, PIM generated by the filters of the transmission (TX) radio chains in the antenna system at the cell site, loose cable connections, dirty connectors, poor performance duplexers, and aged antennas, is called internal PIM whereas PIM generated by a metal fence on the roof top of a building, a metal roof, or even a drainpipe, in vicinity of the cell site is called external PIM. External PIM thus refers to the case where the PIM occurs after the signals have left the transmitter antenna with the resultant intermodulation reflecting back into the receiver. PIM might cause the transmission power of the cell site to be backed off in order to avoid PIM to affect the receiver (RX) radio chains in the antenna system of the cell site, thus compromising the network performance. For example, a 1-dB drop in uplink sensitivity caused by PIM might reduce coverage by as much as 11% in a macro network. Further, PIM is a super-linear effect, meaning that the PIM power can increase as a power of the downlink transmit power. For example, for third-degree PIM every decibel (dB) of transmit power increase could result in 3 dB of PIM power increase in the uplink.

To explain how PIM is generated at a high level, consider FIG. 1. FIG. 1 at (a) illustrates a communications network 100 where embodiments presented herein can be applied. The communications network 100 comprises an access network node 110, such as a radio access network node, radio base station, base transceiver station, node B (NB), evolved node B (eNB), gNB, access point, integrated access and access node, etc. configured to provide network access to user equipment 120a, 120b in carriers 120a, 120b. A PIM source 130 is located in the vicinity of the antenna system of the access network node 110. FIG. 1 at (b) shows a representation of the power spectral density (PSD) as a function of frequency. In the example of FIG. 1, downlink transmission in two frequency bands with carrier frequencies f₁ and f₂ mix nonlinearly in the PIM source 130. This results in new interference signals with a variety of center frequencies. Only one of these signals is shown in the power spectral density, centered at the frequency f_{PIM}=2f₁−f₂. In this case, it is for illustrative purposes assumed that the linear combination 2f₁−f₂ happens to be located within the uplink band of the access network node 110, manifesting itself as additional uplink interference. The uplink radio channel for the access network node 110 is marked at reference numeral 140, and the uplink frequency band for the access network node 110 is marked at reference numeral 150. The interference typically has a wider bandwidth than the downlink signals that caused this uplink PIM. This wider bandwidth is an effect of the nonlinear mixing.

PIM generation can be modeled starting with one or more signals transmitted in the downlink that impinge on a PIM source as follows. First, let

$${y}_{k}^{γ} ( t )$$

be the received uplink PIM signal corresponding to the k:th downlink channel:

$${y}_{k}^{γ} ( t ) = ( {h}_{k}^{γ} * {x}_{k} ) ( t )$$

Here γ denotes the PIM source,

$${h}_{k}^{γ}$$

the k:th downlink channel to the PIM source, xₖ the transmitted signal and * denotes convolution. The nonlinear interference generation is modeled as a static nonlinear function;

$${x}^{y} ( t ) = f ( γ , {y}_{1}^{γ} ( t ) , ... , {y}_{K}^{γ} ( t ) ) ,$$

Here x^{γ}(t) is the uplink PIM signal, and

$$f ( γ , {y}_{1}^{γ} ( t ) , … , {y}_{K}^{γ} ( t ) )$$

is the nonlinear function. The received PIM signal can thus be expressed as:

$${y}^{γ} ( t ) = ( {h}^{γ} * {x}^{γ} ) ( t ) .$$

Here h^{γ} is here the uplink channel from the PIM source. An expansion of the nonlinear function can now be performed using multi-dimensional polynomials, as motivated by the Stone-Weirstrass theorem. Stochastic signal modeling gives the following Volterra series representation of the PIM signal after some computations:

$${y}^{γ} ( t ) = {\sum }_{n} ( \int … \int {H}^{n} ( {τ}_{1}^{1} , … , {τ}_{k}^{m} , … , {τ}_{K}^{{n}_{K}} ) {\prod }_{k = 1}^{K} {\prod }_{m = 1}^{{n}_{k}} {x}_{k} ( t - {τ}_{k}^{m} ) d {τ}_{k}^{m} )$$

$${H}^{n} ( {τ}_{1}^{1} , … , {τ}_{k}^{m} , … , {τ}_{K}^{{n}_{K}} ) = \int \int ( {\prod }_{k = 1}^{K} {\prod }_{m = 1}^{{n}_{k}} {f}_{γ}^{n} {h}^{γ} ( τ ) {h}_{k}^{γ} ( {τ}_{k}^{m} - τ ) ) d τ d γ .$$

Here

$${τ}_{k}^{m}$$

of special cases of the above model verifies the frequency shift and spreading of signals outlined for FIG. 1 above. The details are omitted here. Note that the superscript (·)ⁿ is the degree, or non-linear order, of the PIM source.

Three types of common techniques to mitigate the impact of PIM, namely uplink PIM cancellation, downlink PIM avoidance by beamformed transmission, and general power reducing PIM avoidance, will be briefly summarized next.

PIM cancellation algorithms are designed to estimate parts of the complete PIM channel from downlink transmission to uplink reception. Given the estimated signal, and the downlink transmissions a predicted signal can be computed and subtracted from the received signal. In case the predicted signal is an accurate model of the received uplink PIM, a substantial reduction in the uplink PIM can be obtained. One common drawback of all PIM cancellation algorithms is the computational complexity. This computational complexity is much higher than that of conventional channel estimation since non-linear basis functions must be created. PIM cancellation also requires measurement of both downlink transmission and uplink PIM.

PIM avoidance by beamformed transmission aims at avoiding beams of an advanced antenna system used for transmission to be pointed in the direction of the PIM source. This might require estimation of the location of the PIM source, which might not be knowns in advance. Therefore, techniques have been proposed to estimate a subspace of the beam space generated by the antenna array system where the PIM source is located. Generation of beams in this subspace is then avoided for downlink transmissions. This technique is only applicable for advanced antenna systems, and thus for (radio) access network nodes equipped with large antenna arrays. Further, this technique limits the number of possible directions in which beams can be used for downlink transmission.

PIM avoidance in general is applicable to any type of access network node. Once the frequency bands in which downlink transmissions are used that cause the uplink PIM are identified, the uplink PIM can be reduced by at least periodically avoiding transmission in these identified frequency bands. PIM avoidance can thereby reduce the uplink PIM depending on how much of the frequency bands that can be muted. For network deployments a set of restrictions is defined on how much muting in downlink transmissions is allowed, as an upper limit on how much downlink throughput and capacity can be sacrificed. The implication is that the muting might be implemented sporadically and non-continuously, essentially adding more variations to the uplink signal to interference and noise ratio (SINR). Variations in the SINR must be considered carefully when used in uplink link adaptation, since the uplink PIM is mixed with the interference from other user equipment 120a, 120b.

Hence, there is still a need for improved PIM mitigation techniques.

### SUMMARY

An object of embodiments herein is to provide techniques for efficient PIM avoidance that does not suffer from the issues noted above, or where the above noted issues at least have been mitigated or reduced.

According to a first aspect there is presented a method for PIM avoidance. The method is performed by a nonlinear controller. The method comprises determining, based on presence of uplink PIM, to which fraction of total transmission resources within a transmission slot a set of transmission power reduction factors is to be applied. The fraction of total transmission resources is, in a logarithmic domain and according to a nonlinear feedback control loop, computed as a function of a comparison between a measured uplink PIM when having applied the set of transmission power reduction factors in a most recent transmission slot and a reference value for the uplink PIM. The nonlinear feedback control loop is based on characteristics, having a curved nonlinear envelope, that transforms a control signal expressed in terms of maximum number of resource blocks as allowed to be scheduled within the transmission slot, to a corresponding logarithmic domain downlink power reduction. The measured uplink PIM is given by, in each transmission slot, probing a radio channel over which the uplink PIM is received. The method comprises applying the set of transmission power reduction factors to the determined fraction of total transmission resources as distributed over a set of DL transmission carriers within the transmission slot during transmission of a set of signals in the set of DL transmission carriers.

According to a second aspect there is presented a nonlinear controller for PIM avoidance. The nonlinear controller comprises processing circuitry. The processing circuitry is configured to cause the nonlinear controller to determine, based on presence of uplink PIM, to which fraction of total transmission resources within a transmission slot a set of transmission power reduction factors is to be applied. The fraction of total transmission resources is, in a logarithmic domain and according to a nonlinear feedback control loop, computed as a function of a comparison between a measured uplink PIM when having applied the set of transmission power reduction factors in a most recent transmission slot and a reference value for the uplink PIM. The nonlinear feedback control loop is based on characteristics, having a curved nonlinear envelope, that transforms a control signal expressed in terms of maximum number of resource blocks as allowed to be scheduled within the transmission slot, to a corresponding logarithmic domain downlink power reduction. The measured uplink PIM is given by, in each transmission slot, probing a radio channel over which the uplink PIM is received. The processing circuitry is configured to cause the nonlinear controller to apply the set of transmission power reduction factors to the determined fraction of total transmission resources as distributed over a set of DL transmission carriers within the transmission slot during transmission of a set of signals in the set of DL transmission carrier.

According to a third aspect there is presented a nonlinear controller for PIM avoidance. The nonlinear controller comprises a determine module configured to determine, based on presence of uplink PIM, to which fraction of total transmission resources within a transmission slot a set of transmission power reduction factors is to be applied. The fraction of total transmission resources is, in a logarithmic domain and according to a nonlinear feedback control loop, computed as a function of a comparison between a measured uplink PIM when having applied the set of transmission power reduction factors in a most recent transmission slot and a reference value for the uplink PIM. The nonlinear feedback control loop is based on characteristics, having a curved nonlinear envelope, that transforms a control signal expressed in terms of maximum number of resource blocks as allowed to be scheduled within the transmission slot, to a corresponding logarithmic domain downlink power reduction. The measured uplink PIM is given by, in each transmission slot, probing a radio channel over which the uplink PIM is received. The nonlinear controller comprises an apply module configured to apply the set of transmission power reduction factors to the determined fraction of total transmission resources as distributed over a set of DL transmission carriers within the transmission slot during transmission of a set of signals in the set of DL transmission carrier.

According to a fourth aspect there is presented a computer program for PIM avoidance. The computer program comprises computer code which, when run on processing circuitry of a nonlinear controller, causes the nonlinear controller to perform actions. One action comprises the nonlinear controller to determine, based on presence of uplink PIM, to which fraction of total transmission resources within a transmission slot a set of transmission power reduction factors is to be applied. The fraction of total transmission resources is, in a logarithmic domain and according to a nonlinear feedback control loop, computed as a function of a comparison between a measured uplink PIM when having applied the set of transmission power reduction factors in a most recent transmission slot and a reference value for the uplink PIM. The nonlinear feedback control loop is based on characteristics, having a curved nonlinear envelope, that transforms a control signal expressed in terms of maximum number of resource blocks as allowed to be scheduled within the transmission slot, to a corresponding logarithmic domain downlink power reduction. The measured uplink PIM is given by, in each transmission slot, probing a radio channel over which the uplink PIM is received. One action comprises the nonlinear controller to apply the set of transmission power reduction factors to the determined fraction of total transmission resources as distributed over a set of DL transmission carriers within the transmission slot during transmission of a set of signals in the set of DL transmission carrier.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient PIM avoidance that does not suffer from the issues noted above.

Advantageously, these aspects provide a significant reduction of PIM (UL interference), yet the computational and signaling complexities are negligible.

Advantageously, these aspects allow regulation of any number of aggressor carriers, and/or aggressor carrier sub-bands, thereby providing high PIM reduction, with a minimized DL capacity loss as determined by an optimal greedy algorithm.

Advantageously, these aspects automate the PIM reduction, thereby reducing operating expenses, tracking changing levels of PIM e.g. in busy hours, thereby adjusting the power muting to the minimum needed to keep a set acceptable level of PIM at each point in time.

Advantageously, the measurement of PIM-excess power can be adjusted to match the DL traffic profiles, thereby providing robust performance.

Advantageously, prior knowledge needed for application is restricted to knowledge of an upper bound of the PIM degree, typically 3 or 5.

Advantageously, these aspects can be implemented in a staged low-cost way, since the basic single-aggressor-single-victim nonlinear feedback control loop can be re-used.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIG. 2 is a block diagrams of an access network node and a PIM source according to an embodiment;

FIG. 3 is a block diagram of access network nodes and a PIM source according to an embodiment;

FIG. 4 is a flowchart of methods according to embodiments;

FIG. 5 is a block diagram of a controller implementing a nonlinear feedback control loop according to an embodiment;

FIG. 6 schematically illustrates a quantization function according to an embodiment;

FIG. 7 is a block diagram of a controller implementing a nonlinear feedback control loop according to an embodiment;

FIG. 8 is a block diagram of a controller implementing a nonlinear feedback control loop according to an embodiment;

FIG. 9 is a signalling diagram of a method according to an embodiment;

FIGS. 10-15 shows simulation results according to embodiments;

FIG. 16 is a schematic diagram showing functional units of a nonlinear controller according to an embodiment;

FIG. 17 is a schematic diagram showing functional modules of a nonlinear controller according to an embodiment; and

FIG. 18 shows one example of a computer program product comprising computer readable storage medium according to an embodiment.

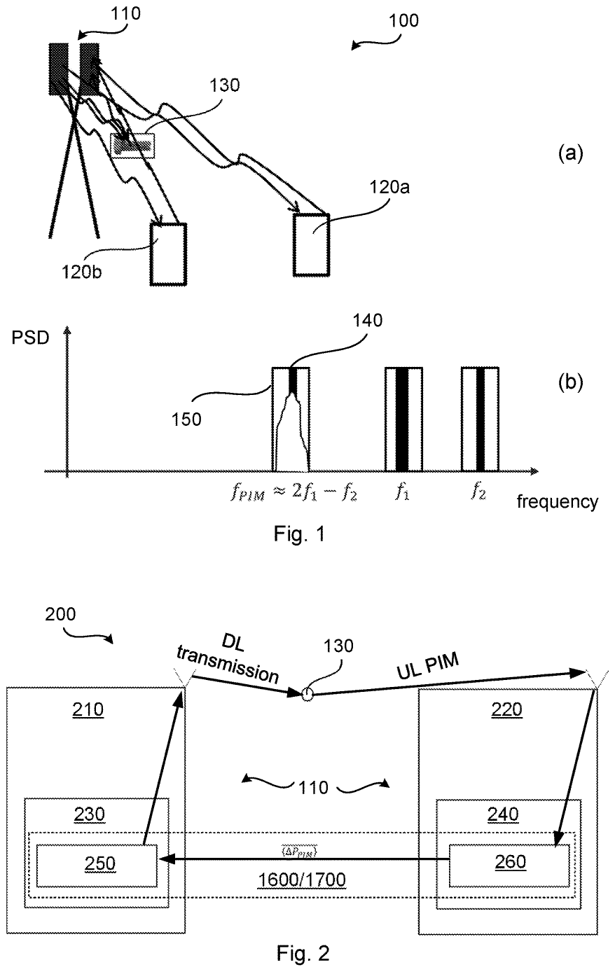

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for improved PIM mitigation techniques.

In this respect, as also noted above, PIM cancellation is associated with a very high computational complexity and requires measurements on multiple downlink and uplink transmissions with high sampling rate. PIM avoidance by beamformed transmission is limited to access network nodes equipped with advanced antenna systems. Traditional PIM avoidance techniques based on muting downlink transmissions may cause significant downlink throughput reductions.

At least some of the herein disclosed embodiments aim at addressing shortcomings of traditional PIM avoidance techniques by considering possible effects of the uplink when performing the PIM avoidance.

The embodiments disclosed herein in particular relate to techniques for PIM avoidance. In order to obtain such techniques, there is provided a nonlinear controller, a method performed by the nonlinear controller, a computer program product comprising code, for example in the form of a computer program, that when run on a nonlinear controller, causes the nonlinear controller to perform the method.

FIG. 2 is a block diagram of a system 200 comprising an access network node 110 and a PIM source 130. In turn, the access network node 110 comprises a controller 1600/1700. The access network node 110 has a transmitter part 210 and a receiver part 220. In turn, the transmitter part 210 comprises a downlink baseband part 230 and the receiver part 220 comprises an uplink baseband part 240. The controller 1700 is partly implemented in the transmitter part 210 and partly in the receiver part 220. In the transmitter part 210 the controller 1600/1700 comprises a feedback control block 250 and in the receiver part 220 the controller 1600/1700 comprises a probing block 260.

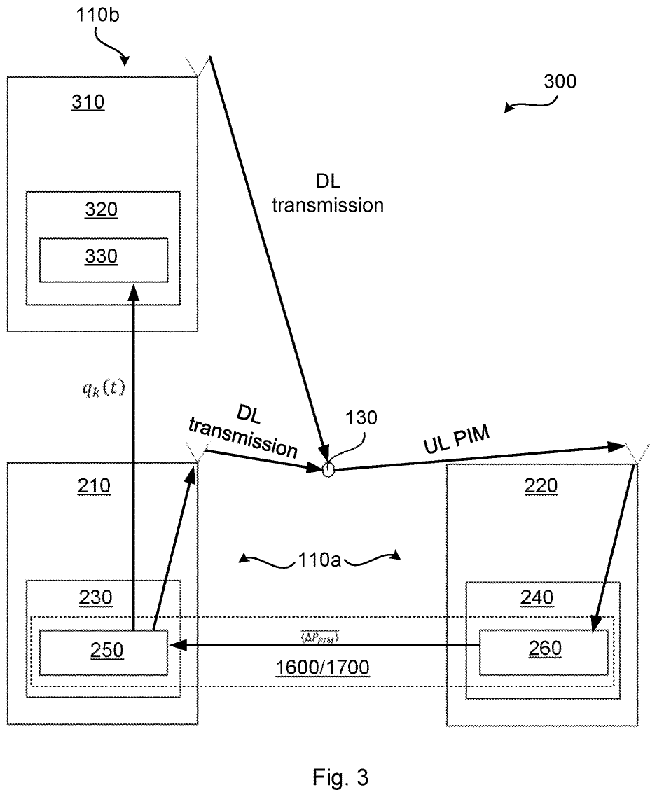

FIG. 3 is a block diagram of a system 300 comprising two access network nodes 110a, 110b and one PIM source 130. In turn, the access network node 110a comprises a controller 1600/1700. The access network node 110a has a transmitter part 210 and a receiver part 220. For the access network node 110b only the transmitter part 310 is shown. In turn, the transmitter parts 210, 310 comprise a respective downlink baseband part 230, 320, and the receiver part 220 comprises an uplink baseband part 240. The controller 1600/1700 is partly implemented in the transmitter part 210 and partly in the receiver part 220. In the transmitter part 210 the controller 1600/1700 comprises a feedback control block 250 and in the receiver part 220 the controller 1600/1700 comprises a probing block 260. The feedback control block 250 is configured to transmit a control signal to an actuator block 330 in the access node 110b for affecting the transmission power of the access node 110b.

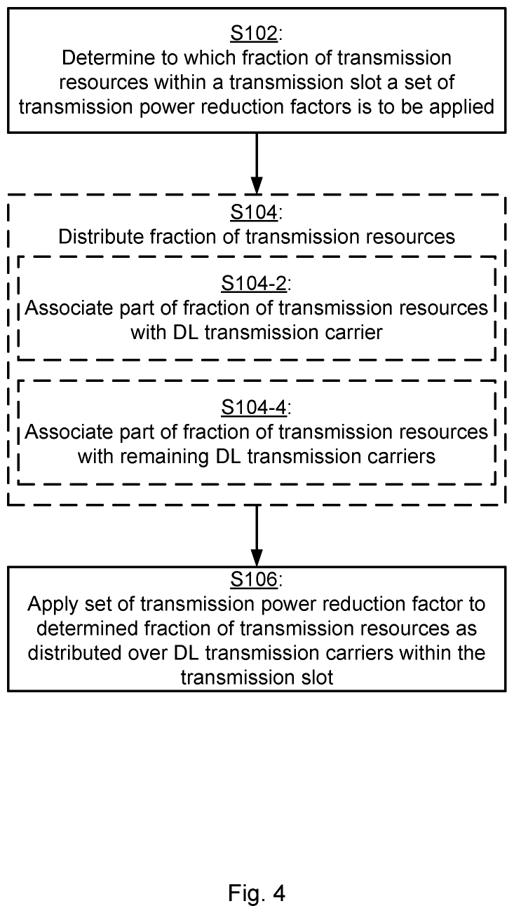

FIG. 4 is a flowchart illustrating embodiments of methods for PIM avoidance. The methods are performed by the nonlinear controller 1600/1700. The methods are advantageously provided as computer programs.

S102: The nonlinear controller 1600/1700 determines, based on presence of uplink PIM, to which fraction of total transmission resources within a transmission slot a set of transmission power reduction factors is to be applied.

The fraction of total transmission resources is, in a logarithmic domain and according to a nonlinear feedback control loop, computed as a function of a comparison between a measured uplink PIM when having applied the set of transmission power reduction factors in a most recent transmission slot and a reference value for the uplink PIM,

The nonlinear feedback control loop is based on characteristics, having a curved nonlinear envelope, that transforms a control signal expressed in terms of maximum number of resource blocks as allowed to be scheduled within the transmission slot, to a corresponding logarithmic domain downlink power reduction.

The measured uplink PIM is given by, in each transmission slot, probing a radio channel over which the uplink PIM is received.

S106: The nonlinear controller 1600/1700 applies the set of transmission power reduction factors to the determined fraction of total transmission resources as distributed over a set of DL transmission carriers within the transmission slot during transmission of a set of signals in the set of DL transmission carriers.

Embodiments relating to further details of PIM avoidance as performed by the nonlinear controller 1600/1700 will now be disclosed with continued reference to FIG. 4.

In some embodiments, the fraction of transmission resources further is determined as a function of control parameters of the nonlinear feedback control loop. In some embodiments, the uplink PIM is upper-bounded by a degree n, and wherein the control parameters depend on the degree n.

It is appreciated that there could be different types of nonlinear feedback control loops. In some embodiments, the nonlinear feedback control loop is either a nonlinear integral (I) feedback control loop or a nonlinear proportional integral (PI) feedback control loop. In some examples, the nonlinear controller 1600/1700 is therefore referred to as either a nonlinear I controller or a nonlinear PI controller.

It is appreciated that there could be different types of transmission resources to which the transmission power reduction factor is applied. In some non-limiting examples, the transmission resources are physical resource blocks (PRBs).

It is appreciated that there could be different ways in which the transmission power reduction factor is applied to, and thus affects, the determined fraction of transmission resources within the transmission slot. In some non-limiting examples, applying the transmission power reduction factor comprises any, or any combination, of: muting the transmission resources to which the transmission power reduction factor is applied, reducing transmission power of the transmission resources to which the transmission power reduction factor is applied, limiting downlink load in at least one carrier to a fixed limit, minimizing downlink load in at least one carrier to a fixed limit, limiting the downlink load from a certain side of downlink carriers when considered in the frequency domain.

It is appreciated that there could be different time intervals at which the probing is performed. In some non-limiting examples, the probing is performed between once every 10:th to once every 1000:th transmission slot, preferably between once every 25:th to every 400:th transmission slot, more preferably between once every 50:th to once every 150:th transmission slot, even more preferably between once every 75:th to once every 125:th transmission slot.

It is appreciated that there could be different transmission slots. In some non-limiting examples, the transmission slot includes all transmission time intervals (TTIs) between two sampling instances.

As disclosed above, the fraction of total transmission power resources is distributed between the set of DL transmission carriers. In some aspects, it is the nonlinear controller 1600/1700 that performs this distribution. Therefore, in some embodiments, the nonlinear controller 1600/1700 is configured to perform (optional) step S104.

S104: The nonlinear controller 1600/1700 distributes the fraction of total transmission power resources between the set of DL transmission carriers.

In some embodiments, the set of DL transmission carriers consists of one single DL transmission carrier. In other embodiments, the set of DL transmission carriers comprises a primary (or main) DL transmission carrier and at least one secondary DL transmission carrier.

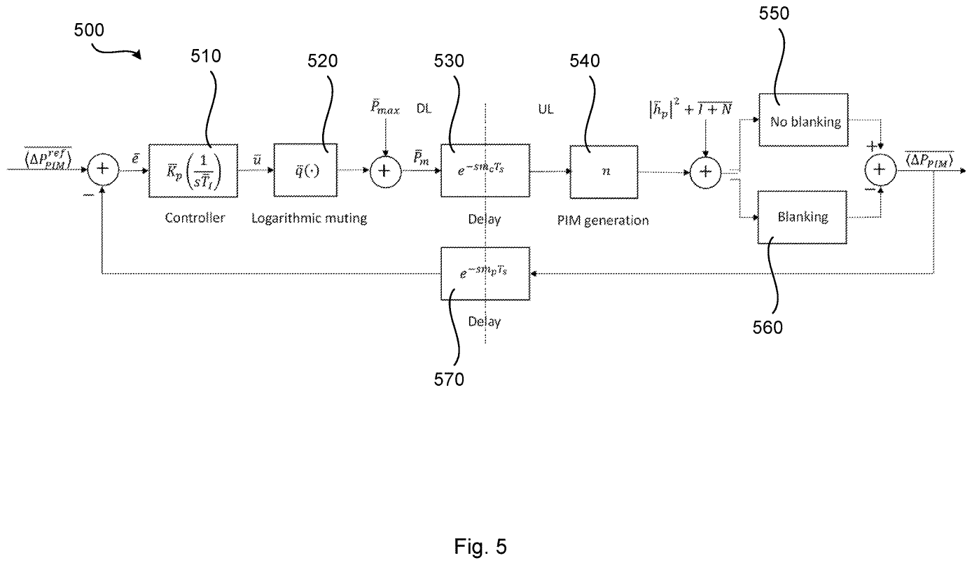

Reference is next made to FIG. 5 in which is shown a block diagram 500 of a feedback control loop as partly implemented by the nonlinear controller 1600/1700 according to embodiments disclosed herein. The nonlinear controller 1600/1700 is in FIG. 5 represented by the controller module 510 and the logarithmic muting module 520. The feedback control loop is executed in the logarithmic domain. For ease of description, bars over variables indicate logarithmic domain. For further ease of description, the notation used in the feedback control loop is given mainly in the frequency domain where s is the Laplace transform variable. The different symbols have meanings as defined in Table 1.

TABLE 1
List of symbols and their meaning

| Symbol | Meaning |
|---|---|
| $\overline{〈 {Δ P}_{PIM}^{ref} 〉}$ | reference value for the remaining UL PIM excess power, in dB |
| [symbol] | measured UL PIM excess power, in dB |
| e^{-sm}ₚ^{T}ₛ | PIM excess power feedback signaling delay, where mₚ is an |
| | integer or rational number and Tₛ is the sampling interval |
| | (implemented in the delay module 570) |
| ē(s) | feedback control error |
| K̅_{P} | proportional gain of the integrating controller |
| | (implemented in the controller module 510) |
| T̅_{I} | integration time of the I controller, in seconds |
| | (implemented in the controller module 510) |
| ū(s) | control signal, expressed in number of PRBs |
| q̅(·) | transformation from bandwidth in terms of the fraction of |
| | resource block groups (RBGs), to dBs of PIM divided by n |
| e^{-sm}_{c}^{T}ₛ | control delay, where m_{c} is an integer or fractional number |
| | (implemented in the delay module 530) |
| n | PIM degree, or an upper bound of the PIM degree |
| | (implemented in the PIM generation module 540) |
| \|h̅ₚ\|² | UL PIM channel power, in dB |
| I̅ +̅ N̅ | interference and noise power, from other UEs and receiver noise |

For ease of description, in the remaining of this disclosure, application of the transmission power reduction factor to the determined fraction of transmission resources will be exemplified by muting a fraction of PRBs. In this respect, selective and dynamic muting of a fraction of the PRBs means that PRBs only in the needed fraction of the frequency band, to achieve a certain PIM level, are muted. Traditionally, all PRBs in the frequency band, or the frequency band corresponding to certain user(s) are muted. The fractional muting (implemented in the logarithmic muting module 520) might be implemented in the scheduler, that then only schedules the blocks of PRBs that are not marked as muted.

To describe the overall operation of the nonlinear feedback control loop, consider FIG. 5. The reference value for the accepted (relative) PIM excess power level in steady state is found to the left as the (typical operator) parameter value

$$\overline{〈 Δ {P}_{PIM}^{ref} 〉} .$$

The measured PIM excess power level as compared to the other interference is denoted [symbol] and it is subtracted from the reference value to form the control error e after the feedback signaling delay e^{-sm}^{ₚ}^{T}^{ₛ} has affected the measurement. The control error is used to perform I-control. The parameters of that controller are K̅_{P} and T̅_{I} and they are computed as disclosed below. The I-controller generates the control signal ū, which is the input to the actuator mechanism. This actuator mechanism limits, in the logarithmic domain, the fraction of RGBs that are allowed to be scheduled on the data channel. This block is hence a static nonlinear limiting quantizer, denoted q̅(·). The quantization is performed in the time domain, although this is not shown in FIG. 5. Following limitation, the limited power denoted P̅ₘ is formed by addition of the maximum transmit power of the carrier, P̅ₘₐₓ. The data is then scheduled and transmitted, and after a delay e^{-sm}^{_{c}}^{T}^{ₛ} PIM power shows up in the UL as a factor of n times the transmitted power. The factor n can therefore be regarded as the degree of the controlled aggressor carrier in the dominating PIM product of the PIM model. For intermodulation 3 (IM3) the value of n may therefore be 1 or 2. According to the block diagram, the PIM channel power |hₚ|^{2a}nd the other interference, as represented by I̅+̅N̅ affecting the UL, are thereafter injected. The logarithmic domain nonlinear feedback control loop does not have any PIM channel gain being a part of the loop gain. Therefore, it is only the degree n that affects the stability of the nonlinear feedback control loop, which is an advantage since otherwise PIM channel estimation would be needed. The measurement of [symbol] is represented by two branches of the signal chain; one branch (represented by the no blanking module 550) that continuously measures the sum of the PIM and the other interference and another branch (represented by the blanking module 560) that measures only the other interference, much less frequently by blanking the DL aggressor carrier. The difference is the sought PIM excess power. Further aspects of this measurement will be disclosed below.

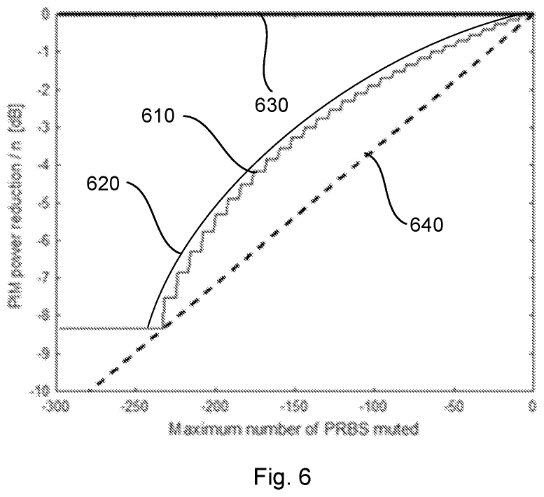

Aspects of the actuator characteristics used for modeling the transformation from the control signal (expressed in terms of the maximum number of PRB groups that is allowed for scheduling) and the PIM excess power in dBs that results of this muting will be disclosed next. In some aspects, the transformation can be regarded as a threshold used for fractional (and dynamic in time) muting with respect to the maximum data traffic of the aggressor carrier. Traditionally, the whole frequency band, or at least the frequency band corresponding to certain user(s), have been subject to static muting, and hence not dynamic muting determined by a nonlinear controller 1600/1700 using a nonlinear feedback control loop. The dynamic muting might be implemented in a scheduler that then only schedules PRBs up to the dynamic muting threshold. Since the scheduling typically schedules blocks of PRBs, so called resource block groups (RBGs), the details of the logarithmic muting can be described by FIG. 6 In FIG. 6 is illustrated characteristics of a static nonlinear quantizer and limiter 610, together with its envelope 620, and the associated sector condition limited by the horizontal line 630 and the dashed line 640. As shown in FIG. 6, and in some embodiments, the curved nonlinear envelope 620 has a logarithmic shape. As further shown in FIG. 6, and in some embodiments, the characteristics 610 is step-valued. For the numerical values in the figure, n=2, mₘᵢₙ=4, Q_{PRB}=8 and mₘₐₓ=34 (272 PRBs). In case of full buffer traffic, the remaining transmission power after applying the set of transmission power reduction factors is in the logarithmic domain expressed as

$${\overline{P}}_{m} ( t ) = 10 log ( {P}_{max} ( t ) q ( \overline{u} ( t ) ) ) = 10 log ( {P}_{max} ( t ) ) + 10 log ( q ( \overline{u} ( t ) ) ) = {\overline{P}}_{max} ( t ) + \overline{q} ( \overline{u} ( t ) ) ,$$

where t is the time, P̅ₘₐₓ (t) is the maximum transmission power, ū(t) is the control signal defined below and q̅(ū(t)) is the control signal quantization function (i.e., the characteristics) in dB when muting. As above, ū(t) denotes the number of PRBs. The maximum transmission power is formally time varying since the input-output stability analysis assumes that the radio transmission is turned on at time zero. The quantization function can then be given by

$$\overline{q} ( \overline{u} ( t ) ) = \{ \begin{matrix}0. , & \overline{u} ( t ) > {u}_{max} \\ {\overline{q}}_{Q} ( \overline{u} ( t ) ) , & {u}_{min} \leq \overline{u} ( t ) \leq {u}_{max} \\ {\overline{q}}_{min} , & \overline{u} ( t ) < {u}_{min}\end{matrix}$$

Here uₘᵢₙ and uₘₐₓ are the lower and upper muting limits, while

$${\overline{q}}_{min} = 10 log \vert \frac{{Q}_{PRB} ⌊ ( {m}_{min} {Q}_{PRB} + {Q}_{PRB} ) / {Q}_{PRB} ⌋}{{m}_{max} {Q}_{PRB}} \vert ,$$

$${\overline{q}}_{Q} ( \overline{u} ( t ) ) = 10 log \vert \frac{{Q}_{PRB} ⌊ ( \overline{u} ( t ) + {Q}_{PRB} + {m}_{max} {Q}_{PRB} ) / {Q}_{PRB} ⌋}{{m}_{max} {Q}_{PRB}} \vert .$$

Further, mₘᵢₙ and mₘₐₓ are the minimum and maximum number of remaining RBGs when muting and └·┘ denotes the floor function. The muting might be held constant during the TTIs in between PIM-A feedback control updates, i.e., between sampling time instances. Further, ū(t) is negative, see FIG. 6.

Further, q̅ₘᵢₙ follows from q̅_{Q}(ū(t)), using ū(t)=uₘᵢₙ=mₘᵢₙ Q_{PRB}−mₘₐₓ Q_{PRB} which represents the part of the spectrum that is not allowed to be muted. Furthermore uₘₐₓ=−Q_{PRB} to ensure stability via the sector condition discussed below.

To determine a value of mₘᵢₙ it is noted that the muting as designed affects all downlink power. However, in the implementation control channel parts are assumed to be left unchanged to avoid coverage effects. This means that the minimum number of RBGs that may be muted is larger than the μ_{control}mₘₐₓQ_{PRB}, where

$${μ}_{control} = \frac{{P}_{max}^{control}}{{P}_{max}} .$$

The factor n of the block diagram of FIG. 6 follows since

$${\overline{P}}_{PIM} ( t ) = 10 log ( {\vert {h}_{p} \vert}^{2} {( {P}_{m} ( t ) )}^{n} ) = 20 log ( \vert {h}_{p} ( t ) \vert ) + n 10 log ( {P}_{m} ( t ) ) = {\vert {\overline{h}}_{p} \vert}^{2} ( t ) + n ( {\overline{P}}_{m} ( t ) ) .$$

One advantage with logarithmic control is obtained by the transformation of the PIM generating block from |hₚ|²(·)ⁿ in the linear domain to simply n in the logarithmic domain. This follows from the equation right above. The fact that only n appears in the loop gain leads to the global stability criterion below and the tuning only in terms of n. In the linear domain the PIM channel gain would appear in the nonlinear feedback control loop and therefore also in the corresponding linear domain stability criterion. The tuning of the nonlinear controller 1600/1700 in the linear domain would therefore require knowledge of the PIM channel. Since the PIM channel is very computationally complex to estimate, it follows that logarithmic feedback control of PIM as disclosed herein also offers a significantly lower implementational complexity, than standard linear domain methodology.

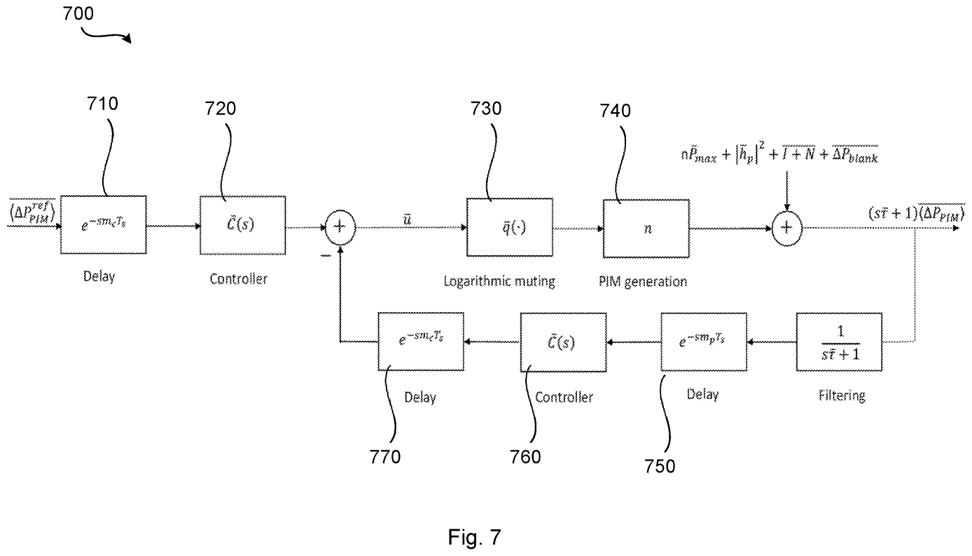

Noting that delays can be interchanged with static nonlinear functions, it follows that the block diagram 500 of FIG. 5 can be re-drawn into the block diagram 700 of FIG. 7. In FIG. 7, C̅(s) denotes the transfer function of the nonlinear controller 1600/1700. The probing block is approximated with an additional term Δ̅P̅_̅{̅b̅l̅a̅n̅k̅}̅. The nonlinear controller 1600/1700 is in FIG. 7 represented by the controller module 720 and the logarithmic muting module 730. By comparing FIG. 5 and FIG. 7, the following quantities result

$${u}_{1} ( s ) = n {\overline{P}}_{max} + {\vert {h}_{p} \vert}^{2} + \overline{I + N} + \overline{Δ {P}_{blank}}$$

$${u}_{2} ( s ) = {e}^{- {sm}_{c} {T}_{s}} \overline{C} ( s ) \overline{〈 Δ {P}_{PIM}^{ref} 〉} ( s )$$

$$\hat{g} ( s ) = {e}^{- s ( {m}_{c} + {m}_{p} ) {T}_{s}} \overline{C} ( s )$$

$$φ ( \cdot ) = n \overline{q} ( \cdot )$$

The following assumptions (B1 and B2) are then introduced:
B1: C̅(s) (implemented in controller module 720) is proper and asymptotically stable (implying that s can be replaced by s+δ̅, for some small value of δ̅, in the I controller).
B2: q̅(·) (implemented in the logarithmic muting module 730) is bounded from below by a continuous function with rounded corners, q̅_{ϵ}(·).

The Circle Criterion is then applicable since ĝ(s) is asymptotically stable by B1 and strictly proper by B1. In addition, φ(·) is continuous by B2.

To proceed with the analysis the following conditions (B3 and B4) related to the sector condition are now needed:
B3: The last quantization step occurs for ū=ūₘₐₓ<0.
B4: A bound on the PIM order (i.e., degree), n (as implemented by the PIM generation module 740), is known.

To obtain analytical results, useful for tuning the special case of pure integral control is considered, this means that

$$\overline{C} ( s ) = \frac{{\overline{K}}_{p}}{{\overline{T}}_{I}} \frac{1}{s} .$$

This case is also practically relevant since integration provides filtering as well. In this case a direct calculation shows that the Circle Criterion results in the stability condition

$$- sin ( ( {m}_{c} + {m}_{p} ) ω {T}_{s} ) > - \frac{( {m}_{c} + {m}_{p} ) ω {T}_{s}}{( \frac{{\overline{K}}_{p}}{{\overline{\overline{T}}}_{I}} n \frac{10 log ( ( {m}_{min} + 1 ) / {m}_{max} )}{( {m}_{min} + 1 - {m}_{max} ) {Q}_{PRB}} ) ( ( {m}_{c} + {m}_{p} ) {T}_{s} )} ,$$

$$∀ ω$$

It can be seen that the total controller gain

$$\frac{{\overline{K}}_{p}}{{\overline{T}}_{I}} n$$

affects the stability and that the gain can be arbitrarily distributed between the controller and the quantizer. A further analysis of the stability condition can be done. It is noted that

$$- sin ( ( {m}_{c} + {m}_{p} ) ω {T}_{s} )$$

$$and$$

$$- \frac{ω}{( \frac{{\overline{K}}_{p}}{{\overline{T}}_{I}} ) n \frac{10 log ( ( {m}_{min} + 1 ) / {m}_{max} )}{( {m}_{min} + 1 - {m}_{max} ) {Q}_{PRB}}}$$

intersect at ω=0. If the slope of

$$- sin ( ( {m}_{c} + {m}_{p} ) ω {T}_{s} )$$

is less negative than

$$- \frac{1}{( \frac{{\overline{K}}_{p}}{{\overline{T}}_{I}} ) n \frac{10 log ( ( {m}_{min} + 1 ) / {m}_{max} )}{( {m}_{min} + 1 - {m}_{max} ) {Q}_{PRB}}}$$

at ω=0, there will be no intersections for ω>0 since

$$\frac{d}{d ω} ( - sin ( ( {m}_{c} + {m}_{p} ) ω {T}_{s} ) )$$

is minimal in ω=0. Hence, the following condition implies that the Circle Criterion implies global stability:

$$- ( {m}_{c} + {m}_{p} ) {T}_{s} > - \frac{1}{( \frac{{K}_{p}}{{T}_{I}} ) n \frac{10 log ( ( {m}_{min} + 1 ) / {m}_{max} )}{( {m}_{min} + 1 - {m}_{max} ) {Q}_{PRB}}}$$

which implies that

$$( \frac{10 log ( ( {m}_{min} + 1 ) / {m}_{max} )}{( {m}_{min} + 1 - {m}_{max} ) {Q}_{PRB}} ( \frac{{\overline{K}}_{p}}{{\overline{T}}_{I}} ) n ) ( {m}_{c} + {m}_{p} ) {T}_{s} < 1$$

This is implemented in delay modules 710, 750, 770 and in the controller module 720 and in the logarithmic muting module 730.

The product of the total controller gain and the loop delay thus needs to be sufficiently small. In case one increases the other needs to decrease to maintain the stability margin, a fact that is intuitively clear, considering that loop delay is an enemy of feedback.

This criterion is useful for tuning, as pointed out above. However, it can be made less conservative by an application of the Popov Criterion. To use the Popov Criterion the following additional conditions (B5 to B8) are needed:
B5: The interference and noise I̅+̅N̅ is input output stable in the L₂ norm.
B6: The PIM channel gain |h̅ₚ|² is input output stable in the L₂ norm.
B7: Δ̅P̅_̅{̅b̅l̅a̅n̅k̅}̅ is input output stable in the L₂ norm.
B8:

$$\overline{〈 Δ {P}_{PIM}^{ref} 〉}$$

is input output stable in the L₂ norm.

The Popov Criterion is then applicable since ĝ(s) is asymptotically stable by B1 and strictly proper by B1 and hence ĝ∈Â and \dot{ĝ}∈Â. Furthermore, φ(·) is continuous by B2, u₁ and u₂ are in L₂ by B1, B5-B8, and \dot{u}₂ is in L₂ by B1, B5-B8.

A direct computation then gives the Popov curve

$$Re ( k \hat{g} ( j ω ) ) = n \frac{10 log ( ( {m}_{min} + 1 ) / {m}_{max} )}{( {m}_{min} + 1 - {m}_{max} ) {Q}_{PRB}} \frac{{\overline{K}}_{p}}{{\overline{T}}_{I}} \frac{sin ( ( {m}_{c} + {m}_{p} ) ω {T}_{s} )}{ω} = - ( ( n \frac{10 log ( ( {m}_{min} + 1 ) / {m}_{max} )}{( {m}_{min} + 1 - {m}_{max} ) {Q}_{PRB}} \frac{{\overline{K}}_{p}}{{\overline{T}}_{I}} ) ( {m}_{c} + {m}_{p} ) {T}_{s} ) \frac{sin ( ( {m}_{c} + {m}_{p} ) {T}_{s} ω )}{( {m}_{c} + {m}_{p} ) {T}_{s} ω}$$

$$ω Im ( k \hat{g} ( j ω ) ) = - ( n \frac{10 log ( ( {m}_{min} + 1 ) / {m}_{max} )}{( {m}_{min} + 1 - {m}_{max} ) {Q}_{PRB}} \frac{{\overline{K}}_{p}}{{\overline{T}}_{I}} ) ( ( {m}_{c} + {m}_{p} ) {T}_{s} ) \frac{cos ( ( {m}_{c} + {m}_{p} ) {T}_{s} ω )}{( {m}_{c} + {m}_{p} ) {T}_{s}}$$

A closer study of the stability limit case, results in the following stability condition:

$$( \frac{10 log ( ( {m}_{min} + 1 ) / {m}_{max} )}{( {m}_{min} + 1 - {m}_{max} ) {Q}_{PRB}} \frac{{\overline{K}}_{p}}{{\overline{T}}_{I}} n ) ( ( {m}_{c} + {m}_{p} ) {T}_{s} ) < 1.6$$

The above global stability condition can be used for easy configuration of the nonlinear controller 1600/1700, where the only PIM-related prior knowledge that is needed is a bound on the maximal PIM degree. This information might, for example, be known from measurements taken at PIM sites. Typically, the delays, mₘᵢₙ, mₘₐₓ and Q_{PRB} are also known.

A computer implementation of the nonlinear feedback control loop requires discretization. Continuous time differential equations can be transformed to discrete time difference equations, so that stability is preserved. Tustin's approximation that preserves linear stability by a dedicated conformal mapping can therefore be selected. Tustin's approximation is given by

$$s \to \frac{2}{{T}_{s}} \frac{1 - {q}^{- 1}}{1 + {q}^{- 1}}$$

Here q⁻¹ denotes the one step backward shift operator, i.e q⁻¹x(t)=x(t−T_{S}) for any signal, where T_{S} denotes the sampling period. The discretized I controller becomes

$$\overline{u} ( t ) = \overline{u} ( t - {T}_{S} ) + \frac{{\overline{K}}_{P} {T}_{S}}{2 {\overline{T}}_{I}} ( \overline{e} ( t ) + \overline{e} ( t - {T}_{S} ) )$$

The computational complexity is low. The controller requires storage space for two states and the computations amount to one addition and one multiply and add operation, per update.

Anti-windup actions, such as feeding back limited control signals to the integrator state, can be used to mitigate windup. Such anti-windup is applied in the simulations below.

The loop-gain-loop-delay stability conditions leads to an automatic tuning procedure, only requiring knowledge of the logarithmic quantizer parameters, the delays, the PIM degree and the selection of the integration time. That is, in some embodiments, the feedback control loop meets a global stability criterion that depend on the degree n. The quantizer parameters are Q_{PRB}, known from the implementation, mₘᵢₙ and mₘₐₓ, also known from the implementation. The delays are m_{c}Tₛ known or accessible from the implementation or standard, as well as mₚTₛ which is the signaling delay. This should be available in a single node implementation but may need measurement in an inter-node scenario, then an average or typical value is sufficient. The PIM degree n is often known to the operator, if not, a configured default upper bound can be used. The integration time T̅_{I} can e.g., be selected as an integer number of sampling periods, at least 10. Then the Popov loop-gain-loop-delay condition can be solved for K̅ₚ and the tuning is finalized. Hence, in some embodiments, the feedback control loop has a proportional gain K̅ₚ, and wherein the proportional gain K̅ₚ is determined from the global stability criterion. A few dBs of margin can be incorporated in the tuning. The above thus leads to the following formula for computation of the proportional gain K̅ₚ

$${\overline{K}}_{p} = 1.6 \frac{{\overline{T}}_{I}}{( {m}_{c} + {m}_{p} ) {T}_{S}} \frac{1}{n} \frac{( {m}_{min} + 1 - {m}_{max} ) {Q}_{PRB}}{10 log ( ( {m}_{min} + 1 ) / {m}_{max} )} {10}^{- \overline{γ} / 10} ,$$

where T̅_{I} is integration time, m_{c} is a first integer or fractional number representing downlink delay, mₚ is a second integer or fractional number representing uplink delay, Tₛ is sampling interval, n is uplink PIM order (i.e., degree), mₘᵢₙ and mₘₐₓ are minimum and maximum number of remaining RBGs when applying the set of transmission power reduction factors, Q_{PRB} is number of resource blocks per groups of resource blocks, and γ̅ is a stability gain margin in dB.

Probing can be used to measure the PIM excess power. The block diagram of FIG. 5 depicts the probing as two blocks, one applied during normal operation and one when maximum muting (i.e., blanking) is applied. Since the maximum muting removes the effect of PIM, the other block measures the total effect of interference, noise and PIM. The difference between the outputs of the two blocks thus represents the power caused by PIM, in the logarithmic domain. This quantity is [symbol] which is the quantity that is controlled.

Some transmission schemes have been deployed that operate by collection of traffic data until the complete bandwidth of a TTI has been filled. Only then is a DL transmission triggered. One advantage is e.g., energy savings since parts of the radio circuitry may be turned off in between transmitting TTIs.

This might cause the transmission power to become comparatively high, which may give rise to very high momentary PIM levels. When not transmitting, PIM will disappear. The controller may here be configured to react to a PIM burst, for example by being pre-informed about the transmission event. Such pre-information may be obtained by signaling from the scheduler to the PIM controller. When this is not possible, e.g., due to signaling delay, or a too complicated implementation, one effect might be that the measured PIM excess may be dominated by TTIs without data transmission, leading to an underestimated PIM excess power measurement. In turn, one consequence will might be application of too little muting at the nonlinear feedback controller. According to embodiments disclosed herein is therefore disclosed a measurement principle and signal processing means to counteract this effect, while retaining the possibility to select a measurement for traffic that is evenly distributed over time.

Some of the embodiments disclosed herein are based on the use of measurement of the average UL interference power for each TTI between two consecutive sampling time instances, where the averages are stored between sampling instances. Some of the embodiments disclosed herein are based on the buildup of an experimental probability distribution, of the UL average interference powers per TTI, e.g., in terms of a histogram. Still further, some of the embodiments disclosed herein are based on the computation of the x:th percentile of the average interference power, by summation and interpolation based on the experimental probability distribution, and using the x:th percentile average interference power for computation of the non-blanking total interference power measurement branch of FIG. 6. In particular, in some embodiments, information of the measured uplink PIM is represented in terms of an estimated x:th percentile PIM excess power, where 50≤x<100. Finally, some of the embodiments disclosed herein are based on an excess power measurement, being the difference between the x:th percentile total interference power measurement and the total interference power measurements for the latest blanked TTI. In some embodiments, the x:th percentile PIM excess power is estimated from a probability distribution obtained by combining PIM power excess measurements for each transmission time interval, TTI, between two consecutive applications of the set of transmission power reduction factors.

The signaling information may encode the PIM power excess measurement, as well as information on whether an average or an x:th percentile is used (the median is the 50:th percentile). An optional ID of the UL victim carrier, together with a time tag of the measured PIM power excess is also disclosed as optional information elements of the signaling information.

The signaling may take place between basebands within a single LTE, NR or 6G operating network node, or between basebands in different LTE, NR and 6G network nodes, all network nodes constrained to a site. The signaling may also take place between other logical parts than at baseband level.

One objective of the herein disclosed embodiments with respect to multi-aggressor feedback control is to reuse the single-aggressor-single-victim nonlinear feedback control loop algorithm of FIG. 5. It can be observed that one way to achieve the objective is to maintain one assigned main nonlinear feedback control loop and then actuate parts of the nonlinear feedback control loops of the other aggressors. A first step towards such a re-use is a systematic computation of how an optimal distribution of muting would look like, when maximizing the throughput. This requires a model of the PIM power generation. The Volterra series expansion would be a general alternative, however it would be so complex that it would be hard to find guidance on any simple muting distribution. The alternative considered here is therefore to focus on a few simple models to find such guidance.

Assume that the PIM generation is via the model

$${P}_{PIM} ( t ) = {\vert {h}_{p} ( t ) \vert}^{2} {( {P}_{m , 1} ( t ) )}^{{n}_{1}} {( {P}_{m , 2} ( t ) )}^{{n}_{2}} ,$$

where P_{m,1}(t) and P_{m,2}(t) are DL transmission powers of two aggressor carriers, with PIM degrees n₁ and n₂, respectively, and where hₚ(t) is the fading aggregated PIM channel gain. The PIM degree in this case is hence n=n₁+n₂. The above model assumes that one term of the Volterra series dominates over all others, which may not be true in all practical cases. However, the rationale for analyzing this model is to gain insight on how to organize feedback control for the multi-aggressor-single-victim case.

The muting mix is defined by the muting factors q₁ and q₂. Assuming full buffer traffic, this means that the muted PIM power can be expressed as

$${P}_{PIM} = {\vert {h}_{p} ( t ) \vert}^{2} {( {q}_{1} {P}_{m , 1} ( t ) )}^{{n}_{1}} {( {q}_{2} {P}_{m , 2} ( t ) )}^{{n}_{2}}$$

The assumption on full buffer traffic is admittedly a restriction, however it will be relaxed below. For now, it is needed to arrive at guidance on how to organize the feedback control problem.

The muting is applied to reduce PIM from

$${P}_{PIM} = {δ}_{H} ( I + N )$$

down to

$${P}_{PIM , muted} = {δ}_{L} ( I + N ) .$$

Here δ_{H}≥δ_{H} are user selected constants. At this point it is remarked that the formulation assumes muting of a fraction of the traffic which is the case for the feedback controlled dynamic threshold of the single-aggressor-single-victim algorithm, irrespective if the traffic is full buffer or varying. It will not be perfectly true for the other carriers, or when saturation breaks the main nonlinear feedback control loop. Then the dynamic thresholds will rather act as fix thresholds on varying (random) traffic, more along this line is described below. As stated above the reduction of the PIM shall be obtained maximizing the DL throughput. The downlink throughput is quantified by

$$V ( {q}_{1} , {q}_{2} ) = {q}_{1} + {q}_{2} .$$

Merging these facts leads to the following maximization problem

$$( \begin{matrix}{\hat{q}}_{1} \\ {\hat{q}}_{2}\end{matrix} ) = {arg}_{{q}_{1} , {q}_{2}} max V ( {q}_{1} , {q}_{2} )$$

$$subject to$$

$$\frac{{P}_{PIM , muted}}{{P}_{PIM}} = {q}_{1}^{{n}_{1}} {q}_{2}^{{n}_{2}} = \frac{{δ}_{L}}{{δ}_{H}} = Δ ,$$

$${q}_{1} ∈ [ {q}_{1 , min} , 1 ] , {q}_{1 , min} > 0 , and$$

$${q}_{2} ∈ [ {q}_{2 , min} , 1 ] , {q}_{2 , min} > 0$$

The above optimization problem is well structured. Solving the main constraint equation for q₂ and inserting the result in V(q₁, q₂) results in the loss function

$$V ( {q}_{1} ) = {q}_{1} + {Δ}^{\frac{1}{{n}_{2}} {q}_{1}^{- \frac{{n}_{1}}{{n}_{2}}}} .$$

Any extreme point fulfills

$$0 = \frac{dV}{{dq}_{1}} = 1 + {Δ}^{\frac{1}{{n}_{2}}} ( - \frac{{n}_{1}}{{n}_{2}} ) {q}_{1}^{- ( \frac{{n}_{1}}{{n}_{2}} + 1 )} .$$

Another differentiation renders

$$\frac{{d}^{2} V ( {q}_{1} )}{{dq}_{1}^{2}} = {Δ}^{\frac{1}{{n}_{2}}} ( \frac{{n}_{1}}{{n}_{2}} ) ( \frac{{n}_{1}}{{n}_{2}} + 1 ) {q}_{1}^{- ( \frac{{n}_{1}}{{n}_{2}} + 2 )} > 0.$$

Hence, the only possible internal extreme point is a (local) minimum point. It follows that the maximum solution must be obtained at the boundary of the remaining constraint set

$${q}_{1} ∈ [ {q}_{1 , min} , 1 ] , {q}_{2} ∈ [ {q}_{2 , min} , 1 ] .$$

To analyze the problem further, the constraint set is investigated. To find the optimum all possibilities need to be separately evaluated, followed by selection of the best boundary solution. The constraint set has 4 sides and 4 corners and each case needs to be evaluated.

Case 1, \hat{q}₁=1.

This gives

$${\hat{q}}_{2} = max ( {q}_{2 , min} , {Δ}^{\frac{1}{{n}_{2}}} )$$

$${V}_{1} ( {q}_{1} , {q}_{2} ) = 1 + max ( {q}_{2 , min} , {Δ}^{\frac{1}{{n}_{2}}} ) .$$

Case 2, \hat{q}₁=q_{1,min}.

This requires that

$$Δ < {q}_{1 , min}^{{n}_{1}}$$

and gives

$${\hat{q}}_{2} = max ( {q}_{2 , min} , {q}_{1 , min}^{- \frac{{n}_{1}}{{n}_{2}}} {Δ}^{\frac{1}{{n}_{2}}} )$$

$${V}_{2} ( {q}_{1} , {q}_{2} ) = 1 + max ( {q}_{2 , min} , {q}_{1 , min}^{- \frac{{n}_{1}}{{n}_{2}}} {Δ}^{\frac{1}{{n}_{2}}} ) .$$

Case 3, \hat{q}₂=1.

This gives

$${\hat{q}}_{1} = max ( {q}_{1 , min} , {Δ}^{\frac{1}{{n}_{1}}} )$$

$${V}_{3} ( {q}_{1} , {q}_{2} ) = 1 + max ( {q}_{1 , min} , {Δ}^{\frac{1}{{n}_{1}}} ) .$$

Case 4 \hat{q}₂=q_{2,min}.

This requires that

$$Δ < {q}_{2 , min}^{{n}_{2}}$$

and gives

$${\hat{q}}_{1} = max ( {q}_{1 , min} , {q}_{2 , min}^{- \frac{{n}_{2}}{{n}_{1}}} {Δ}^{\frac{1}{{n}_{1}}} )$$

$${V}_{4} ( {q}_{1} , {q}_{2} ) = 1 + max ( {q}_{1 , min} , {q}_{2 , min}^{- \frac{{n}_{2}}{{n}_{1}}} {Δ}^{\frac{1}{{n}_{1}}} ) .$$

Case 5 \hat{q}₁=1,\hat{q}₂=1.

This requires that Δ=1 and gives

V₅(q₁,q₂)=2.

Case 6 \hat{q}₁=1, \hat{q}₂=q_{2,min}.

This requires that

$$Δ = {q}_{2 , min}^{{n}_{2}}$$

and gives

$${V}_{6} ( {q}_{1} , {q}_{2} ) = 1 + {q}_{2 , min} = 1 + {Δ}^{\frac{1}{{n}_{2}}}$$

Case 7, \hat{q}₁=q_{1,min}, \hat{q}₂=1.

This requires that

$$Δ = {q}_{1 , min}^{{n}_{1}}$$

and gives

$${V}_{7} ( {q}_{1} , {q}_{2} ) = 1 + {q}_{1 , min} = 1 + {Δ}^{\frac{1}{{n}_{1}}} .$$

Case 8, \hat{q}₁=q_{1,min}, \hat{q}₂=q_{2,min}.

This requires that

$$Δ = {q}_{1 , min}^{{n}_{1}} {q}_{2 , min}^{{n}_{2}}$$

and gives

$${V}_{8} ( {q}_{1} , {q}_{2} ) = {q}_{1 , min} + {q}_{2 , min} .$$

There are now three intervals to consider. The following properties (P1 and P2) are utilized:
P1:

$$0 < {x}^{\frac{1}{n}} < 1$$

is increasing in (0,1], and
P2:

$${x}^{\frac{1}{{n}_{1}}} > {x}^{\frac{1}{{n}_{2}}}$$

in (0,1] for n₁>n₂.

Therefore, to understand the way an algorithm should be designed, assume that n₁>n₂.

Δ=1. Only case 5 applies and V (q₁, q₂)=V₅(q₁, q₂)=2.

Δ<1 but large so none of q₁ or q₂ is at its lower limit. Then cases 1 or 3 applies and due to property P2 above

$${V}_{3} ( {q}_{1} , {q}_{2} ) > {V}_{1} ( {q}_{1} , {q}_{2} ) ,$$

which implies

$${\hat{q}}_{2} = 1 , {\hat{q}}_{1} = {Δ}^{\frac{1}{{n}_{1}}} ,$$

i.e., muting on aggressor carrier 1 (with largest exponent). This continues to be the case until q₁ hits the lower limit. \hat{q}₂=1 remains to be the case.

Then

$$Δ = {q}_{1 , min}^{\frac{1}{{n}_{1}}} , {\hat{q}}_{2} = 1 ,$$

which is case 7, and hence

$$V ( {q}_{1} , {q}_{2} ) = 1 + {q}_{1 , min} = 1 + {Δ}^{\frac{1}{{n}_{1}}} ,$$

and \hat{q}1 cannot decrease.

Then

$$Δ = {q}_{1 , min}^{\frac{1}{{n}_{1}}} , {\hat{q}}_{1} = {q}_{1 , min}$$

and q₂<1. This situation continues until no further muting is possible. Then case 8 is reached.

It can thus be observed that this can be used to design a greedy algorithm for muting, with the greediness expressed in the PIM degree value. In some embodiments, the fraction of total transmission power resources is thus distributed between the set of DL transmission carriers according to a greedy algorithm.

With the guidance from the dual aggressor case, the multiple aggressor case can be analyzed. In this case the PIM generation is assumed to be via the model

$${P}_{PIM} ( t ) = {\vert {h}_{p} ( t ) \vert}^{2} {\prod }_{k = 1}^{K} {( {P}_{m , k} ( t ) )}^{{n}_{k}} ,$$

where P_{m,k}(t), k=1, . . . , K are DL transmission powers of K aggressor carriers, with PIM degrees nₖ, and where hₚ(t) is the fading, aggregated PIM channel gain. The PIM degree in this case is

$$n = {\sum }_{k = 1}^{K} {n}_{k} .$$

The above model again assumes that one term of the Volterra series dominates over all others, which may not be the true in all practical cases.

The muting mix is defined by the muting factors qₖ, k=1, . . . , K. This means that the muted PIM power can be expressed as

$${P}_{PIM , muted} ( t ) = {\vert {h}_{p} ( t ) \vert}^{2} {\prod }_{k = 1}^{K} {( {q}_{k} {P}_{m , k} ( t ) )}^{{n}_{k}}$$

This muting is applied to reduce PIM from (High)

$${P}_{PIM} = {δ}_{H} ( I + N )$$

down to (Low)

$${P}_{PIM , muted} = {δ}_{L} ( I + N ) .$$

This reduction shall be obtained while maximizing throughput. The downlink throughput is quantified by

$$V ( {q}_{1} , … , {q}_{K} ) = {\sum }_{k = 1}^{K} {q}_{k} .$$

Merging these facts leads to the following maximization problem

$$( \begin{matrix}{\hat{q}}_{1} \\ ⋮ \\ {\hat{q}}_{K}\end{matrix} ) = {argmax}_{{q}_{1} , … , {q}_{K}} V ( {q}_{1} , … , {q}_{K} ) = {argmax}_{{q}_{1} , … , {q}_{K}} {\sum }_{k = 1}^{K} {q}_{k}$$

$$subject to$$

$$\frac{{P}_{PIM , muted}}{{P}_{PIM}} = {q}_{1}^{{n}_{1}} ⋯ {q}_{K}^{{n}_{K}} = \frac{{δ}_{L}}{{δ}_{H}} = Δ ,$$

$${q}_{k} ∈ [ {q}_{k , min} , 1 ] , {q}_{k , min} > 0 , k = 1 , … , K$$

Again, the problem becomes clean with a specific structure.

A solution of the optimization problem will be disclosed next. A formal treatment requires augmentation of the main constraint with a Lagrange multiplier, giving

$$( \begin{matrix}{\hat{q}}_{1} \\ ⋮ \\ {\hat{q}}_{K} \\ \hat{λ}\end{matrix} ) = {argmax}_{{q}_{1} , … , {q}_{K} , λ} {V}_{λ} ( {q}_{1} , … , {q}_{K} , λ ) = {argmax}_{{q}_{1} , … , {q}_{K} , λ} {\sum }_{k = 1}^{K} {q}_{k} + λ ( {q}_{1}^{{n}_{1}} ⋯ {q}_{K}^{{n}_{K}} - Δ )$$

$$subject to$$

$${q}_{k} ∈ [ {q}_{k , min} , 1 ] , {q}_{k , min} > 0 , k = 1 , … , K$$

Beginning with interior points, the conditions for an interior extreme point are

$$\frac{\partial {V}_{λ}}{\partial {q}_{l}} = 1 + λ {n}_{l} {q}_{l}^{{n}_{l - 1}} {\prod }_{k \neq l}^{K} {q}_{k}^{{n}_{k}} = 0 , l = 1 , … , K ,$$

$$\frac{\partial {V}_{λ}}{\partial λ} = {q}_{1}^{{n}_{1}} ⋯ {q}_{K}^{{n}_{K}} - Δ = 0 .$$

Another differentiation yields

$$\frac{{\partial }^{2} {V}_{λ}}{\partial {q}_{l} \partial {q}_{m}} = λ {n}_{l} {n}_{m} {q}_{l}^{{n}_{l - 1}} {q}_{m}^{{n}_{m} - 1} {\prod }_{l \neq k \neq m \neq l}^{K} {q}_{k}^{{n}_{k}}$$

$$\frac{{\partial }^{2} {V}_{λ}}{\partial {q}_{l}^{2}} = λ {n}_{l} ( {n}_{l} - 1 ) {q}_{l}^{{n}_{l - 2}} {\prod }_{k \neq l}^{K} {q}_{k}^{{n}_{k}}$$

$$\frac{{\partial }^{2} {V}_{λ}}{\partial {q}_{l} \partial λ} = {n}_{l} {q}_{l}^{{n}_{l - 1}} {\prod }_{k \neq l}^{K} {q}_{k}^{{n}_{k}} = 0 , l = 1 , … , K$$

$$\frac{{\partial }^{2} {V}_{λ}}{\partial λ \partial {q}_{l}} = \frac{{\partial }^{2} {V}_{λ}}{\partial {q}_{l} \partial λ}$$

$$\frac{{\partial }^{2} {V}_{λ}}{\partial λ} = 0 .$$

To proceed, the last of the first order conditions is inserted in the first K conditions, and the following equations are obtained: qₖ+λnₖΔ=0, for k=1, . . . , K.

Reinserting these yields

$${\prod }_{k = 1}^{K} {( ( - λ ) {n}_{k} Δ )}^{{n}_{k}} = Δ .$$

This leads to

$${( - λ )}^{n} {Δ}^{n} {\prod }_{k = 1}^{K} {n}_{k}^{{n}_{k}} = Δ ,$$

where it was exploited that

$$n = {\sum }_{k = 1}^{K} {n}_{k} .$$

This simplifies to

$$- λ = \frac{{Δ}^{\frac{1 - n}{n}}}{{\prod }_{k = 1}^{K} {n}_{k}^{{n}_{k}}} .$$

The final result therefore becomes

$${q}_{k} = \frac{{n}_{k}}{{\prod }_{k = 1}^{K} {( {n}_{k} )}^{{n}_{k}}} {Δ}^{\frac{1}{n}} , k = 1 , … , K .$$

The condition for a maximum point is that the Hessian is negative definite. In case it is never negative definite, the maximum value must be achieved on the boundary. The reasoning for dual aggressors can then be directly extended to give the algorithm listed further down.

Calculation of the components of the Hessian follow by insertion of the values and intermediate results obtained for −λ and qₖ above. The result is

$$\frac{{\partial }^{2} {V}_{λ}}{\partial {q}_{l} \partial {q}_{m}} = λ {n}_{l} {n}_{m} {q}_{l}^{{n}_{l - 1}} {q}_{m}^{{n}_{m} - 1} {\prod }_{l \neq k \neq m \neq l}^{K} {q}_{k}^{{n}_{k}} = - {Δ}^{- \frac{1}{n}} {\prod }_{k = 1}^{K} {( {n}_{k} )}^{{n}_{k}}$$

$$\frac{{\partial }^{2} {V}_{λ}}{\partial {q}_{l}^{2}} = λ {n}_{l} ( {n}_{l} - 1 ) {q}_{l}^{{n}_{l - 2}} {\prod }_{k \neq l}^{K} {q}_{k}^{{n}_{k}} = - \frac{{n}_{l} - 1}{{n}_{l}} {Δ}^{- \frac{1}{n}} {\prod }_{k = 1}^{K} {( {n}_{k} )}^{{n}_{k}}$$

$$\frac{{\partial }^{2} {V}_{λ}}{\partial {q}_{l} \partial λ} = {n}_{l} {q}_{l}^{{n}_{l - 1}} {\prod }_{k \neq l}^{K} {q}_{k}^{{n}_{k}} = {Δ}^{1 - \frac{1}{n}} {\prod }_{k = 1}^{K} {( {n}_{k} )}^{{n}_{k}} = \frac{{\partial }^{2} {V}_{λ}}{\partial λ \partial {q}_{l}}$$

$$\frac{{\partial }^{2} {V}_{λ}}{\partial λ} = 0 .$$

The existing combinations in Table 2 were analyzed numerically for 3 and 4 aggressors. Each eigenvalue signature has been calculated based on 10 values of 4, logarithmically distributed between 0.01 and 1, and all 10 results are required to have the same eigenvalue structure to be listed in Table 2. As can be seen in Table 2, the eigenvalue signatures are all the same, indicating indefiniteness. Hence the algorithm that is disclosed below, denoted a degree greedy algorithm, is conjectured to be the general optimizing algorithm, for all finite PIM degrees.

TABLE 2
Numerical eigenvalue signatures of the Hessian.

| K | n | n₁, . . . , n_{K} | Eigenvalue signature (signs) |
|---|---|---|---|
| 2 | 3 | 2, 1 | −1, 1, 1 |
| 2 | 5 | 4, 1 | −1, 1, 1 |
| 2 | 5 | 3, 2 | −1, 1, 1 |
| 2 | 7 | 6, 1 | −1, 1, 1 |
| 2 | 7 | 5, 2 | −1, 1, 1 |
| 2 | 7 | 4, 3 | −1, 1, 1 |
| 3 | 3 | 1, 1, 1 | −1, 1, 1, 1 |
| 3 | 5 | 3, 1, 1 | −1, 1, 1, 1 |
| 3 | 5 | 2, 2, 1 | −1, 1, 1, 1 |
| 3 | 7 | 5, 1, 1 | −1, 1, 1, 1 |
| 3 | 7 | 4, 2, 1 | −1, 1, 1, 1 |
| 3 | 7 | 3, 3, 1 | −1, 1, 1, 1 |
| 3 | 7 | 3, 2, 2 | −1, 1, 1, 1 |
| 4 | 5 | 2, 1, 1, 1 | −1, 1, 1, 1, 1 |
| 4 | 7 | 4, 1, 1, 1 | −1, 1, 1, 1, 1 |
| 4 | 7 | 3, 2, 1, 1 | −1, 1, 1, 1, 1 |
| 4 | 7 | 2, 2, 2, 1 | −1, 1, 1, 1, 1 |

A degree greedy algorithm will now be described for the full buffer case. The parameter qₜₒₜ denotes the total control to distribute (if possible) and q_{acc} denotes the total amount of control allocated to aggressor carriers, so far.

In some aspects, the degree greedy algorithm is based on muting the carrier that yields highest return in reduced PIM in dB per muted dB of power. If this muting is not sufficient, muting can be continued for the carrier that yields the second highest return in reduced PIM in dB per muted dB of power, etc.

Therefore, in some embodiments, a respective amount of the uplink PIM is caused by each of the DL transmission carriers, and distributing the fraction of total transmission power resources between the set of DL transmission carriers in S104 comprises S104-2 and S104-4.

S104-2: The controller associates at least part of the fraction of total transmission power resources with the DL transmission carrier yielding highest improvement of the uplink PIM per transmission power reduction factor.

S104-4: The controller iteratively associates any remaining fraction of total transmission power resources with the remaining DL transmission carriers, with one remaining DL transmission carrier per iteration, and for each iteration selects the remaining DL transmission carrier yielding highest improvement of the uplink PIM per transmission power reduction factor.

In some embodiments, the DL transmission carrier yielding highest improvement of the uplink PIM per transmission power reduction factor is determined as the DL transmission carrier having highest PIM product exponent.

In some embodiments, as much of the fractions of total transmission power resources as possible is associated with the DL transmission carrier yielding highest improvement of the uplink PIM per transmission power reduction factor.

In some embodiments, distributing the fractions of total transmission power resources between the set of DL transmission carriers yield a set of power adjustment commands, one per DL transmission carrier, and applying the set of transmission power reduction factors to the determined fraction of total transmission resources comprises providing the power adjustment commands to a transmitter of the DL transmission carrier.

In pseudo-code, the degree greedy algorithm can be expressed as follows.

```
Inputs: nₖ, q_{min,k}, k = 1, . . . , K, k sorted in descending order of nₖ.
Outputs: qₖ, k = 1, . . . , K.
Degree greedy algorithm - full buffer case:
k = 1
ready = false
${q}_{tot} = \frac{\vert \overline{u} \vert}{{m}_{max} {Q}_{PRB}}$
qₖ = 1, k = 1, . . . , K
q_{acc} = 0
while k ≤ K and not ready
    $if {q}_{k , min} < 1 - \frac{{n}_{1}}{{n}_{k}} ( {q}_{tot} - {q}_{acc} )$
      ${q}_{k} = 1 - \frac{{n}_{1}}{{n}_{k}} ( {q}_{tot} - {q}_{acc} )$
      ready = 1
    else
        qₖ = q_{k,min}
        ${q}_{acc} = {q}_{acc} + \frac{{n}_{k}}{{n}_{1}} ( 1 - {q}_{k , min} )$
        k = k + 1
    end
end
```

The scaling with the quotient n₁/nₖ is needed since the feedback control muting command is related to n₁ via the loop gain. The muting gain is reduced when the degree decreases. The algorithm in the above form assumes that the muting actually occurs. Since the main aggressor is feedback controlled this is the case for this loop whenever it is not in saturation. However, since the factors qₖ for the other aggressors operates as thresholds in the scheduler, after saturation of the higher degree aggressors, they will either need to always mute the factor of the demanded traffic, or be based e.g., on expected effects of a random traffic model. This is so since muting of a fraction of the demanded traffic would be different from the main aggressor loop where a threshold is controlled in the scheduler that acts as a dynamic limiter, with respect to the entire downlink frequency band. To reuse the single-aggressor-single-victim design, such a further modification is described next.

When re-used, the single-aggressor-single-victim loops will still implement a threshold with respect to the entire carrier frequency band, while the optimization problem leading to the degree greedy algorithm above assumes that an optimized fraction of the incoming traffic is strictly removed. This will be the case when the main aggressor loop operates in the unsaturated regime, since then the dynamic threshold is adjusted until the reference value is achieved. However, in practice the traffic might not be of full buffer character and the actual aggressor power limitation might not be enough to reach the PIM avoidance target in cases where the main aggressor loop has saturated and secondary aggressor muting is needed. This situation is addressed with a modification of the above degree greedy algorithm, where the expected muting of a threshold qₖ operates on a random traffic model. This leads to a compensation factor and a modification of the computation of qₖ.

In case of varying traffic, the effect of an aggressor power limitation that has not been obtained with un-saturated regulation will be less than in the full buffer case. The following permanent traffic distribution over the carrier frequency band is introduced

$${P}_{m , k} ( t ) = {p}_{k} ( t ) {P}_{max , k} \qquad {p}_{k} ( t ) ∈ {f}_{k} ( [ 0 , 1 ] )$$

Here fₖ is the normalized probability distribution of the traffic power distribution, defined on [0,1]. The factor P_{max,k} is cancelled in the degree greedy algorithm, as above.

Next, the traffic distribution, conditioned on the incoming power reduction factor qₖ(t) is computed. Since the muting removes all power above qₖ(t), it follows that the cumulative distribution of the remaining normalized power after limitation, P_{P}_{ₖ}(p|qₖ(t)), is given by

$${P}_{{P}_{k}} ( p \vert {q}_{k} ( t ) ) = Pr ( {p}_{k} ( t ) \leq p \vert {q}_{k} ( t ) )$$

$$= {\int }_{0}^{p} H ( {q}_{k} ( t ) - \tilde{p} ) {f}_{k} ( \tilde{p} ) d \tilde{p} .$$

Here H(·) denotes the Heaviside function. The further treatment is limited to a uniform distribution, i.e.

$${f}_{k} ∈ U ( 0 , 1 )$$

Straightforward computations using the general formula above results in

$${P}_{{P}_{k}} ( p \vert {q}_{k} ( t ) ) = min ( p , {q}_{k} ( t ) ) .$$

A differentiation gives

$${p}_{{P}_{k}} ( p \vert {q}_{k} ( t ) ) = H ( {q}_{k} ( t ) - p ) , p ∈ [ 0 , 1 ] .$$

The expected value of the limited normalized remaining power thus becomes

$$E [ {p}_{k} ( t ) ] = {\int }_{0}^{1} p {p}_{{P}_{k}} ( p \vert {q}_{k} ( t ) ) dp = {\int }_{0}^{1} pH ( {q}_{k} ( t ) - p ) dp = {\int }_{0}^{{q}_{k} ( t )} pdp = \frac{1}{2} {q}_{k}^{2} ( t ) .$$

The expected remaining normalized power after limitation will hence be

$$\frac{1}{2} {q}_{k}^{2} ( t )$$

For example, in case of no limitation, the remaining normalized power will be ½. This leads to the equation for the expected relative reduction of the power, Δ(qₖ(t)), due to a command qₖ(t),

$$Δ ( {q}_{k} ( t ) ) = \frac{1}{2} - \frac{{q}_{k}^{2} ( t )}{2} .$$

Here the factor ½ is due to the uniform distribution and needs to be retained since it needs to be accounted for by the degree greedy algorithm. The alternative to use the full buffer power qₖ(t) would lead to a compensation also when no muting is applied which would be undesirable. Therefore, the alternative “½” might be preferred.

The degree greedy algorithm needs modifications to handle the above effects of random traffic. It is noted again that there is one case where these traffic effects have no or at least small impact. This case is when the main nonlinear feedback control loop is enough in terms of power reduction and therefore operates in the unsaturated regime. This follows since the integrating nonlinear feedback control loop follows the traffic variations and thereby adjusts the limitation to the level where the set PIM reduction is achieved. However, whenever there is a limitation of the main carrier nonlinear feedback control loop, the integrating loop is broken. This means that also secondary carrier thresholds will not reflect the desired reduction of requested traffic.

One modification needed is therefore that when the main carrier control signal saturates, the accumulated control is subject to the fixed threshold traffic effect and so the accumulated control needs to account also for the factor Δ(qₖ(t)), i.e.

$${q}_{acc} = {q}_{acc} + \frac{{n}_{k}}{{n}_{1}} ( \frac{1}{2} - \frac{{q}_{k , min}^{2} ( t )}{2} ) ,$$

where the subscript k here refers to the main aggressor of the victim loop.

Another modification needed is that whenever the main aggressor control is not enough and a second carrier needs to be used, the main carrier has broken the integration loop and the secondary carrier control actions qₖ(t) also need to be modified. The control action previously computed by the degree greedy algorithm, i.e.

$${q}_{k} = 1 - \frac{{n}_{1}}{{n}_{k}} ( {q}_{tot} - {q}_{acc} ) ,$$

therefore needs to be increased according to the factor Δ(qₖ(t)) to have the same average effect as before. The compensation is

$${q}_{k} = 1 - \frac{{n}_{1}}{{n}_{k}} \frac{( {q}_{tot} - {q}_{acc} )}{\frac{1}{2} - \frac{{q}_{k}^{2} ( t )}{2}} .$$

This leads to the following third-degree equation for qₖ

$$\frac{1}{2} {( 1 - {q}_{k} )}^{2} ( 1 + {q}_{k} ) = \frac{{n}_{1}}{{n}_{k}} ( {q}_{tot} - {q}_{acc} ) .$$

Analytical techniques to solve this equation are avoided by noting that the assumption of a uniform distribution extending all the way up to the maximum power of the carrier is quite aggressive. It is therefore assumed that it is reasonable to reduce the qₖ resulting from the third-degree equation. Hence the approximation 1+qₖ≈1 is introduced in the third-degree equation. This reduces the problem to a second-degree equation, which solution that is less than 1 is

$${q}_{k} = 1 - \sqrt{2 \frac{{n}_{1}}{{n}_{k}} ( {q}_{tot} - {q}_{acc} )} .$$

The modification of the degree greedy algorithm hence amounts to introduction of a square root in the condition and computation of the control of the un-saturated secondary carrier.

When the secondary carrier control signal saturates, the accumulated control is subject to the fixed threshold traffic effect and so the accumulated control needs to account for the factor Δ(qₖ(t)) as above, i.e.

$${q}_{acc} = {q}_{acc} + \frac{{n}_{k}}{{n}_{1}} ( \frac{1}{2} - \frac{{q}_{k , min}^{2} ( t )}{2} ) ,$$

where the subscript k here refers to a secondary carrier.

The above discussion leads to the following algorithm, valid for varying traffic:

```
Traffic Degree greedy Algorithm:
Initialization:
k = 1
ready = false
${q}_{tot} = \frac{\vert \overline{u} \vert}{{m}_{max} {Q}_{PRB}}$
qₖ =1, k = 1, . . . , K
q_{acc} = 0
kₘₐᵢₙ = victimLoopAggressorNumber
Algorithm:
Main aggressor:
$if {q}_{{k}_{main} , min} < 1 - \frac{{n}_{{k}_{main}}}{{n}_{{k}_{main}}} ( {q}_{tot} - {q}_{acc} )$
          ${q}_{k} = 1 - \frac{{n}_{{k}_{main}}}{{n}_{{k}_{main}}} ( {q}_{tot} - {q}_{acc} )$
          ready = 1
    else
          qₖ_{ₘₐᵢₙ} = qₖ_{ₘₐᵢₙ},ₘᵢₙ
          ${q}_{acc} = {q}_{acc} + \frac{{n}_{{k}_{main}}}{{n}_{{k}_{main}}} ( \frac{1}{2} - \frac{1}{2} {q}_{{k}_{m a i n}}^{2} )$
    end
Secondary aggressors:
while k ≤ K and not ready
      if k ≠ kₘₐᵢₙ
          $if {q}_{k , min} < 1 - \sqrt{2 \frac{{n}_{{k}_{main}}}{{n}_{k}} ( {q}_{tot} - {q}_{acc} )}$
              ${q}_{k} = 1 - \sqrt{2 \frac{{n}_{{k}_{main}}}{{n}_{k}} ( {q}_{tot} - {q}_{acc} )}$
              ready = 1
      else
              qₖ = 9_{k,min}
              ${q}_{acc} = {q}_{acc} + \frac{{n}_{k}}{{n}_{{k}_{main}}} ( \frac{1}{2} - \frac{1}{2} {q}_{k}^{2} )$
            k = k + 1
        end
  else
    k = k + 1
  end
end
```

It can be noted that the algorithm when executed starts with the main aggressor. This is because of a need to have certain quantities pre-computed by the regulator, in order to run the rest of the algorithm.

The stability of the overall nonlinear feedback control loop is affected by the main feedback control loop, as well as the signal paths of the secondary carriers. As can be seen the gains of these signal paths are proportional to nₖ instead of n₁. This is however handled by the amplification factor n₁/nₖ of the degree greedy algorithm which re-normalizes all gains to n₁.

The anti-windup limitation of the main nonlinear feedback control loop might be adjusted in multi-aggressor cases since the lower (negative) muting limit becomes the sum of the lower control ranges of the involved aggressors. The upper control range remains unaffected.

In some aspects, an overall nonlinear feedback control loop that re-uses one single-aggressor-single-victim nonlinear feedback control loop for the main aggressor with maximum nₖ is used, whilst the nonlinear feedback control loops of the other aggressors are broken up, providing a muting command for computation of their u, using their internal parameters. Their computation of ūₖ(t) is disclosed to be

$${\overline{u}}_{k} ( t ) = - ( 1 - {q}_{k} ( t ) ) {m}_{max , k} {Q}_{PRB , k}$$

where the time t has been re-introduced.

There are several possibilities for this signalling. According to one illustrative example, the value of qₖ is signalled to each of the associated secondary carriers, where one control signal is computed for each of the secondary carriers. The signalling could optionally also include the ID of the main aggressor carrier, the receiving secondary aggressor carrier, as well as a time tag. The signalling may be internal, between basebands in a single LTE, NR or 6G operating network nodes, or between basebands in different LTE, NR or 6G operating network nodes, with all network nodes constrained to one site. The signaling could also occur between other logical blocks than blocks at baseband.

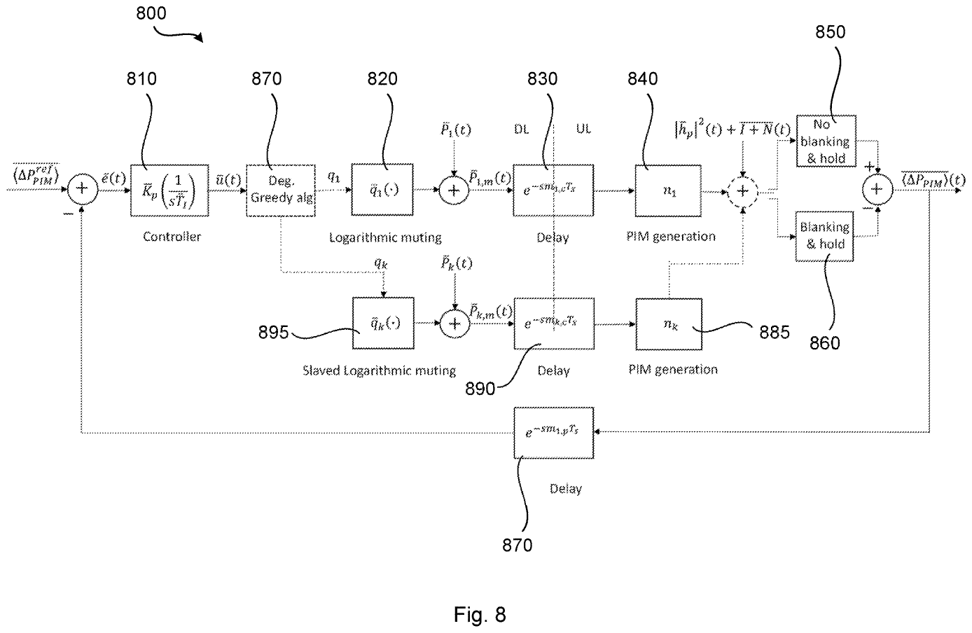

A block diagram 800 of the resulting controller is shown in FIG. 8. In FIG. 8 is shown one main nonlinear feedback control loop for the first carrier (top), and a secondary loop (bottom) for a secondary carrier. Module 8x0 corresponds to module 5x0, where x=1, 2, 3, 4, 5, 6, 7. That is, the nonlinear controller 1600/1700 is in FIG. 8 represented by the controller module 810 and the logarithmic muting module 820. In addition a degree greedy module 870 implements a degree greedy algorithm as herein disclosed. Module 885 corresponds to module 840 for the first carrier but for the secondary carrier. Module 890 corresponds to module 830 for the first carrier but for the secondary carrier. Module 895 corresponds to module 820 for the first carrier but for the secondary carrier. The architecture hence builds on the further modification of the proposed degree greedy algorithm.

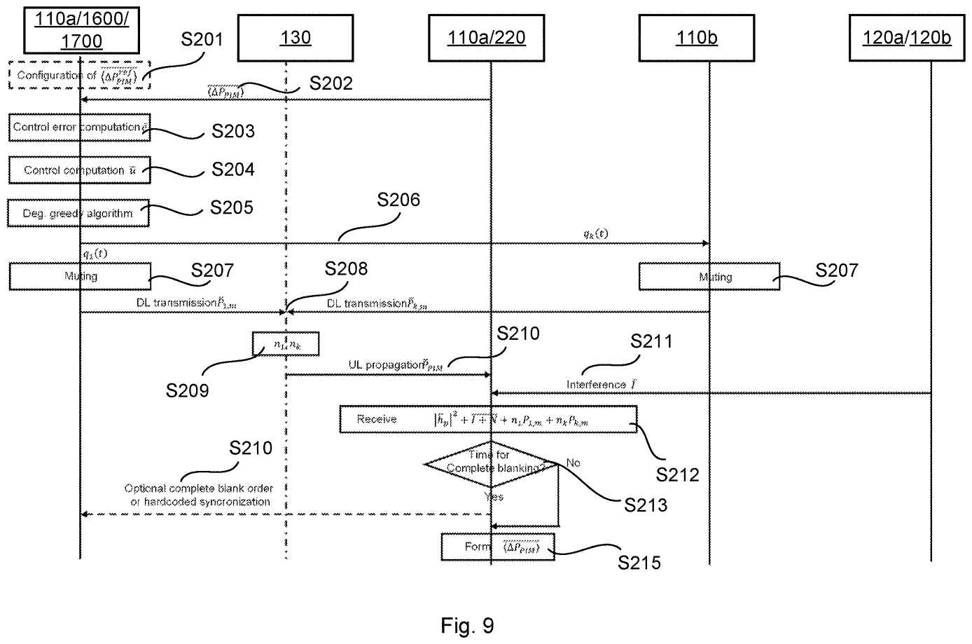

Reference is next made to the signalling diagram of FIG. 9. If not otherwise stated, all values, and all computations, are in the logarithmic domain.
S201: The reference value for the uplink PIM improvement,

$$\overline{〈 Δ {P}_{PIM}^{ref} 〉} ,$$

is configured.
S202: A measured uplink PIM improvement value [symbol] is received.
S203: The control error ē is computed.
S204: The control signal ū is computed.
S205: The degree greedy algorithm is run to compute qₖ(t) for k=1 . . . , K.
S206: The value of qₖ(t) is sent to network node k for k=1 . . . , K.
S207: Muting is applied at network node k for k=1 . . . , K.
S208: A signal is transmitted in the downlink with transmission power P̅_{k,m} for k=1 . . . , K.
S209: The signal transmitted in the downlink is subjected to PIM of degree nₖ for k=1 . . . , K.
S210: The signals as subjected to the PIM is propagated in the uplink.
S211: Interference Ī is received from user equipment 120a/120b.
S212: A signal

$${\vert {\overline{h}}_{p} \vert}^{2} + \overline{I + N} + {\sum }_{k = 1}^{K} {n}_{k} {\overline{P}}_{k , m}$$

is received.
S213: It is determined if it is time for muting all PRBs in the next transmission slot. If Yes, step S214 is entered. Else step S215 is entered.
S214: A control signal is set to mute all PRBs in the next transmission slot, at least for carrier 1. Step S205 can then be entered again for the next transmission slot.
S215: A new measured uplink PIM improvement value <̅Δ̅P̅_̅{̅P̅I̅M̅}̅>̅ is received for the next transmission slot. Step S203 can then be entered again for the next transmission slot.

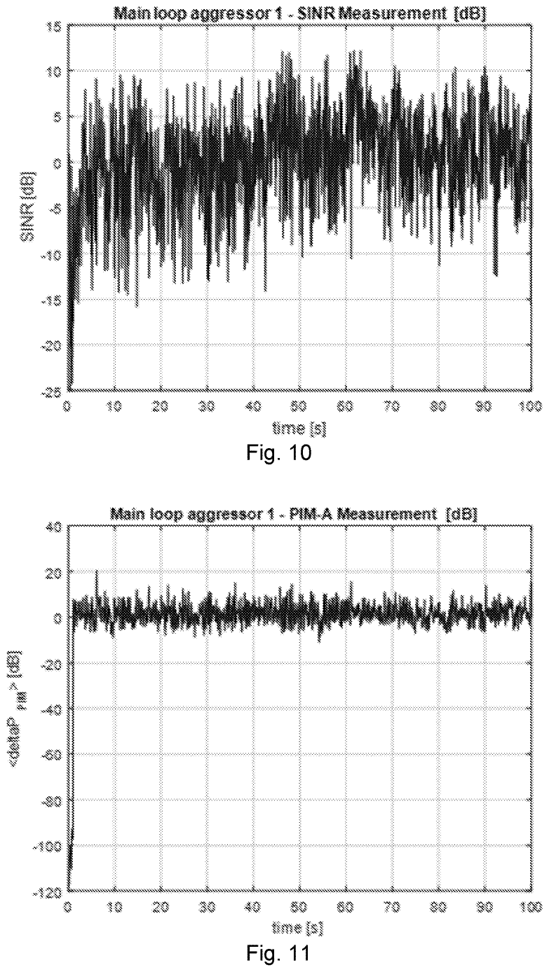

Simulation results will be disclosed next with reference to FIGS. 10-15. The simulation results are based on the following assumptions: Four neighbor cell UEs with path gains 25 dB, 30 dB, 35 dB and 40 dB below the served UE. Pronounced Doppler fading with frequencies 3, 15, 2 and 7 Hz. Interference powers 20 dBm. One PIM source. Received PIM power scaled to give a specified SINR loss, to allow comparison between PIM-A and no PIM-A. Pronounced slow PIM Doppler fading with 1 Hz. A receiver with carrier frequency 100 MHz and a noise figure of 3 dB and. Traffic based on full buffer/full power traffic, and different measured live data power profiles. Further, the following parameter values were used: Tₛ=0.050 s, m_{c}=0, mₚ=1, t_{muted}=1.0 s, 2.0 s, . . . , Pₘₐₓ=100 W, Q_{PRB}=8, mₘₐₓ=34, mₘᵢₙ=4, T̅_{I}=0.50 s, and γ̅=2.0 dB.

First a simulation was performed for a case with two PIM aggressors. An IM3 case with exponents n₁=2, n₂=1 is considered with PIM causing a SINR degradation of about 10 dB. The traffic was simulated with measured traffic profiles. The reference value for the main aggressor victim loop with exponent 2 was selected to be 2.0 dB of remaining excess PIM power. All other parameters were as above.

When running the single-aggressor-single-victim algorithm for the degree 2 exponent carrier, the SINR was increased from −2.6 dB to −0.1 dB. The cost in terms of muted power was −1.5 dB and the average muting threshold was −4.3 dB. When running the single-aggressor-single-victim for the degree 1 exponent the SINR was increased from −3.6 dB to −2.5 dB. The cost in terms of muted power was −1.2 dB and the average muting threshold was −3.4 dB.

The multi-aggressor-single-victim algorithm was then evaluated. The SINR was increased from −2.7 dB to 0.7 dB. The cost in terms of muted power was −1.8 dB on the degree 2 carrier and −1.2 dB on the degree 1 carrier. The average muting thresholds were −4.8 dB and −3.0 dB, respectively.

In summary, the SINR gains for the single-aggressor-single-victim nonlinear feedback control loops were 2.5 dB and 1.1. dB, while the multi-aggressor-single-victim algorithm generated a SINR gain of 3.4 dB.

To illustrate the performance of the multi-aggressor-single-victim, FIG. 10 shows the SINR as a function of time, while the feedback PIM-measurement appears in FIG. 11.

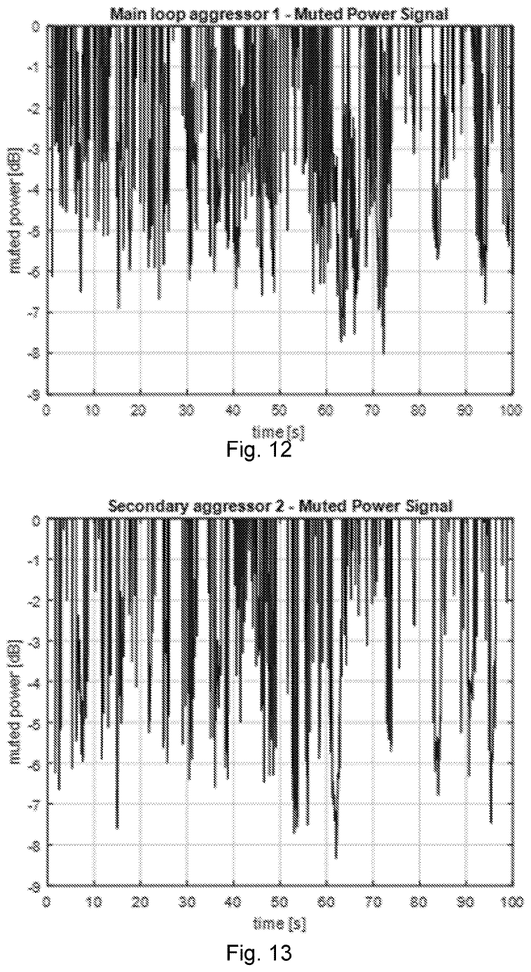

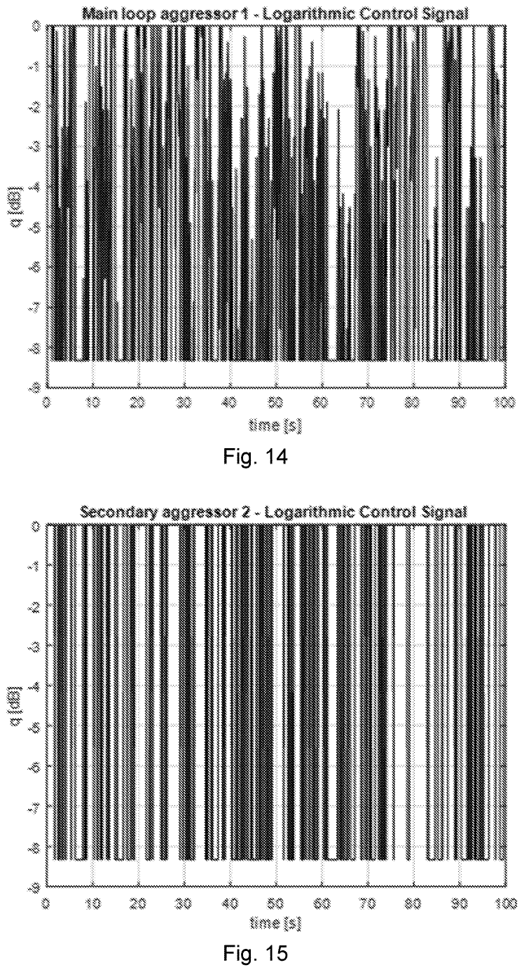

In particular, FIG. 10 shows the SINR as a function of time for the multi-aggressor-single-victim PIM-A algorithm in an IM-3 case, and FIG. 11 shows the PIM excess measurement as a function of time for the multi-aggressor-single-victim PIM avoidance algorithm in an IM-3 case. The muted power signals appear in FIG. 12 and FIG. 13, while the muting thresholds appear in FIG. 14 and FIG. 15. In particular, FIG. 12 shows muted power of the main aggressor as a function of time for the multi-aggressor-single-victim PIM-A algorithm in an IM-3 case, and FIG. 13 shows muted power of the secondary aggressor as a function of time for the multi-aggressor-single-victim PIM avoidance algorithm in an IM-3 case. Further, FIG. 14 shows the logarithmic control signal (muting threshold) of the main aggressor as a function of time for the multi-aggressor-single-victim PIM avoidance algorithm in an IM-3 case, and FIG. 15 shows the logarithmic control signal (muting threshold) of the secondary aggressor as a function of time for the multi-aggressor-single-victim PIM avoidance algorithm in an IM-3 case. It can be concluded that the degree greedy algorithm operates as intended with significant gains over the single-aggressor-single-victim cases.

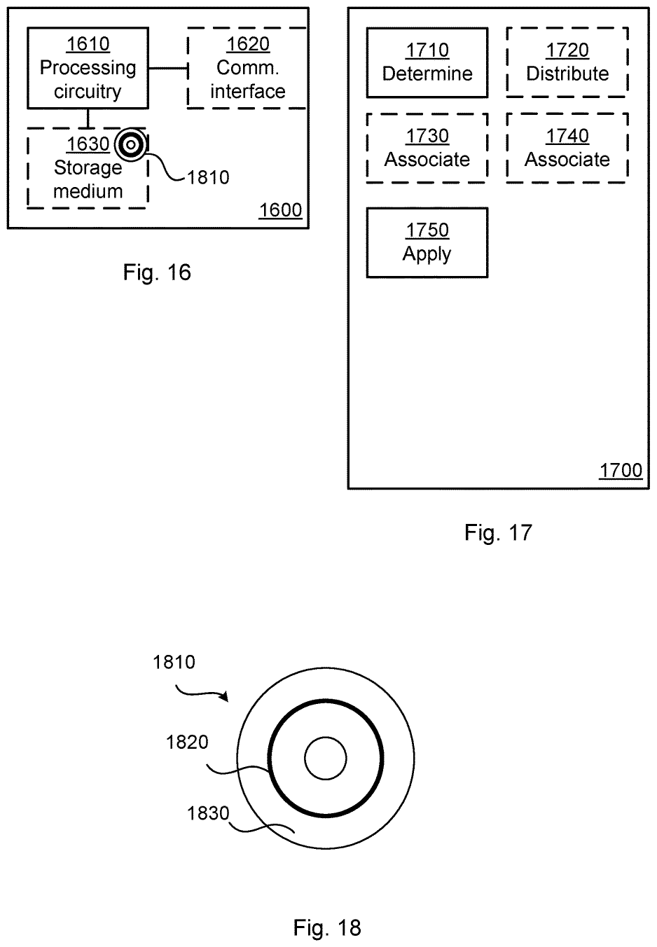

FIG. 16 schematically illustrates, in terms of a number of functional units, the components of a nonlinear controller 1600 according to an embodiment. Processing circuitry 1610 is provided using any combination of one or more of a suitable central processing unit (CPU), multiprocessor, microcontroller, digital signal processor (DSP), etc., capable of executing software instructions stored in a computer program product 1810 (as in FIG. 18), e.g. in the form of a storage medium 1630. The processing circuitry 1610 may further be provided as at least one application specific integrated circuit (ASIC), or field programmable gate array (FPGA).

Particularly, the processing circuitry 1610 is configured to cause the nonlinear controller 1600 to perform a set of operations, or steps, as disclosed above. For example, the storage medium 1630 may store the set of operations, and the processing circuitry 1610 may be configured to retrieve the set of operations from the storage medium 1630 to cause the nonlinear controller 1600 to perform the set of operations. The set of operations may be provided as a set of executable instructions.

Thus the processing circuitry 1610 is thereby arranged to execute methods as herein disclosed. The storage medium 1630 may also comprise persistent storage, which, for example, can be any single one or combination of magnetic memory, optical memory, solid state memory or even remotely mounted memory. The nonlinear controller 1600 may further comprise a communications (comm.) interface 1620 at least configured for communications with other entities, functions, and devices. As such the communications interface 1620 may comprise one or more transmitters and receivers, comprising analogue and digital components. The processing circuitry 1610 controls the general operation of the nonlinear controller 1600 e.g., by sending data and control signals to the communications interface 1620 and the storage medium 1630, by receiving data and reports from the communications interface 1620, and by retrieving data and instructions from the storage medium 1630. Other components, as well as the related functionality, of the nonlinear controller 1600 are omitted in order not to obscure the concepts presented herein.

FIG. 17 schematically illustrates, in terms of a number of functional modules, the components of a nonlinear controller 1700 according to an embodiment. The nonlinear controller 1700 of FIG. 17 comprises a number of functional modules; a determine module 1710 configured to perform step S102, and an apply module 1750 configured to perform step S106. The nonlinear controller 1700 of FIG. 17 may further comprise a number of optional functional modules, such as any of a distribute module 1720 configured to perform step S104, a (first) associate module 1730 configured to perform step S104-2, and a (second) associate module 1740 configured to perform step S104-4. In general terms, each functional module 1710:1750 may in one embodiment be implemented only in hardware and in another embodiment with the help of software, i.e., the latter embodiment having computer program instructions stored on the storage medium 1630 which when run on the processing circuitry makes the nonlinear controller 1600 perform the corresponding steps mentioned above in conjunction with FIG. 17. It should also be mentioned that even though the modules correspond to parts of a computer program, they do not need to be separate modules therein, but the way in which they are implemented in software is dependent on the programming language used. Preferably, one or more or all functional modules 1710:1750 may be implemented by the processing circuitry 1610, possibly in cooperation with the communications interface 1620 and/or the storage medium 1630. The processing circuitry 1610 may thus be configured to from the storage medium 1630 fetch instructions as provided by a functional module 1710: 1750 and to execute these instructions, thereby performing any steps as disclosed herein.

The nonlinear controller 1600/1700 may be provided as a standalone device or as a part of at least one further device. For example, the nonlinear controller 1600/1700 may be provided in a node of an access network or in a node of a core network. Alternatively, functionality of the nonlinear controller 1600/1700 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the nonlinear controller 1600/1700 may be executed in a first device, and a second portion of the of the instructions performed by the nonlinear controller 1600/1700 may be executed in a second device; the herein disclosed embodiments are not limited to any particular number of devices on which the instructions performed by the nonlinear controller 1600/1700 may be executed. Hence, the methods according to the herein disclosed embodiments are suitable to be performed by a nonlinear controller 1600/1700 residing in a cloud computational environment. Therefore, although a single processing circuitry 1610 is illustrated in FIG. 16 the processing circuitry 1610 may be distributed among a plurality of devices, or nodes. The same applies to the functional modules 1710:1750 of FIG. 17 and the computer program 1820 of FIG. 18.

Some (radio) access network architectures define network nodes (or gNBs) comprising multiple component parts or nodes: a central unit (CU), one or more distributed units (DUs), and one or more radio units (RUs). The protocol layer stack of the network node is divided between the CU, the DUs and the RUs, with one or more lower layers of the stack implemented in the RUs, and one or more higher layers of the stack implemented in the CU and/or DUs. The CU is coupled to the DUS via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

FIG. 18 shows one example of a computer program product 1810 comprising computer readable storage medium 1830. On this computer readable storage medium 1830, a computer program 1820 can be stored, which computer program 1820 can cause the processing circuitry 1610 and thereto operatively coupled entities and devices, such as the communications interface 1620 and the storage medium 1630, to execute methods according to embodiments described herein. The computer program 1820 and/or computer program product 1810 may thus provide means for performing any steps as herein disclosed.

In the example of FIG. 18, the computer program product 1810 is illustrated as an optical disc, such as a CD (compact disc) or a DVD (digital versatile disc) or a Blu-Ray disc. The computer program product 1810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1820 is here schematically shown as a track on the depicted optical disk, the computer program 1820 can be stored in any way which is suitable for the computer program product 1810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-26. (canceled)

27. A method for passive intermodulation, PIM, avoidance, the method being performed by a nonlinear controller, the method comprising:
determining (S102), based on presence of uplink PIM, to which fraction of total transmission resources within a transmission slot a set of transmission power reduction factors is to be applied,
wherein the fraction of total transmission resources is, in a logarithmic domain and according to a nonlinear feedback control loop, computed as a function of a comparison between a measured uplink PIM when having applied the set of transmission power reduction factors in a most recent transmission slot and a reference value for the uplink PIM,
wherein the nonlinear feedback control loop is based on characteristics, having a curved nonlinear envelope, that transforms a control signal expressed in terms of maximum number of resource blocks as allowed to be scheduled within the transmission slot, to a corresponding logarithmic domain downlink power reduction, and
wherein the measured uplink PIM is given by, in each transmission slot, probing a radio channel over which the uplink PIM is received; and
applying the set of transmission power reduction factors to the determined fraction of total transmission resources as distributed over a set of downlink, DL, transmission carriers within the transmission slot during transmission of a set of signals in the set of DL transmission carriers.

28. The method according to claim 27, wherein the fraction of transmission resources further is determined as a function of control parameters of the nonlinear feedback control loop.

29. The method according to claim 28, wherein the uplink PIM is upper-bounded by a degree n, and wherein the control parameters depend on the degree n.

30. The method according to claim 27, wherein the feedback control loop meets a global stability criterion that depend on the degree n.

31. The method according to claim 30, wherein the feedback control loop has a proportional gain K̅_{P}, and wherein the proportional gain K̅_{P} is determined from the global stability criterion.

32. The method according to claim 31, wherein the proportional gain K̅_{P} is determined according to:
$${\overline{K}}_{p} = 1.6 \frac{{\overline{T}}_{I}}{( {m}_{c} + {m}_{p} ) {T}_{s}} \frac{1}{n} \frac{( {m}_{min} + 1 - {m}_{max} ) {Q}_{PRB}}{10 log ( ( {m}_{min} + 1 ) / {m}_{max} )} {10}^{- \overline{γ} / 10}$$
where T̅_{I} is integration time, m_{c} is a first integer or fractional number representing downlink delay, mₚ is a second integer or fractional number representing uplink delay, Tₛ is sampling interval, n is uplink PIM degree, mₘᵢₙ and mₘₐₓ are minimum and maximum number of remaining RBGs when applying the set of transmission power reduction factors, Q_{PRB} is number of resource blocks per groups of resource blocks, and γ̅ is a stability gain margin.

33. The method according to claim 27, wherein the set of DL transmission carriers consists of one single DL transmission carrier.

34. The method according to claim 27, wherein the set of DL transmission carriers comprises a primary DL transmission carrier and at least one secondary DL transmission carrier.

35. The method according to claim 1, wherein the curved nonlinear envelope has a logarithmic shape.

36. The method according to claim 27, wherein the characteristics is step-valued.

37. The method according to claim 27, wherein remaining transmission power after applying the set of transmission power reduction factors is in the logarithmic domain expressed as:
$${\overline{P}}_{m} ( t ) = {\overline{P}}_{max} ( t ) + \overline{q} ( \overline{u} ( t ) )$$
where t is the time, P̅ₘₐₓ(t) is a maximum transmission power, ū(t) is the control signal, and q̅(ū(t)) is the characteristics in dB.

38. The method according to claim 27, wherein information of the measured uplink PIM is represented in terms of an estimated x:th percentile PIM excess power, where 50≤x<100.

39. The method according to claim 38, wherein the x:th percentile PIM excess power is estimated from a probability distribution obtained by combining PIM power excess measurements for each transmission time interval, TTI, between two consecutive applications of the set of transmission power reduction factors.

40. The method according to claim 27, wherein the method further comprises:
distributing the fraction of total transmission power resources between the set of DL transmission carriers.

41. The method according to claim 40, wherein the fraction of total transmission power resources is distributed between the set of DL transmission carriers according to a greedy algorithm.

42. The method according to claim 40, wherein a respective amount of the uplink PIM is caused by each of the DL transmission carriers, and wherein distributing the fraction of total transmission power resources between the set of DL transmission carriers comprises:
associating at least part of the fraction of total transmission power resources with the DL transmission carrier yielding highest improvement of the uplink PIM per transmission power reduction factor; and
iteratively associating any remaining fraction of total transmission power resources with the remaining DL transmission carriers, with one remaining DL transmission carrier per iteration, and for each iteration selecting the remaining DL transmission carrier yielding highest improvement of the uplink PIM per transmission power reduction factor.

43. The method according to claim 42, wherein the DL transmission carrier yielding highest improvement of the uplink PIM per transmission power reduction factor is determined as the DL transmission carrier having highest PIM product exponent.

44. A nonlinear controller for passive intermodulation, PIM, avoidance, the nonlinear controller comprising processing circuitry, the processing circuitry being configured to cause the nonlinear controller to:
determine, based on presence of uplink PIM, to which fraction of total transmission resources within a transmission slot a set of transmission power reduction factors is to be applied,
wherein the fraction of total transmission resources is, in a logarithmic domain and according to a nonlinear feedback control loop, computed as a function of a comparison between a measured uplink PIM when having applied the set of transmission power reduction factors in a most recent transmission slot and a reference value for the uplink PIM,
wherein the nonlinear feedback control loop is based on characteristics, having a curved nonlinear envelope, that transforms a control signal expressed in terms of maximum number of resource blocks as allowed to be scheduled within the transmission slot, to a corresponding logarithmic domain downlink power reduction, and
wherein the measured uplink PIM is given by, in each transmission slot, probing a radio channel over which the uplink PIM is received; and
apply the set of transmission power reduction factors to the determined fraction of total transmission resources as distributed over a set of downlink, DL, transmission carriers within the transmission slot during transmission of a set of signals in the set of DL transmission carrier.

45. A non-transitory computer readable medium comprising computer code THAT, when run on processing circuitry of a nonlinear controller, causes the nonlinear controller to:
determine, based on presence of uplink PIM, to which fraction of total transmission resources within a transmission slot a set of transmission power reduction factors is to be applied,
wherein the fraction of total transmission resources is, in a logarithmic domain and according to a nonlinear feedback control loop, computed as a function of a comparison between a measured uplink PIM when having applied the set of transmission power reduction factors in a most recent transmission slot and a reference value for the uplink PIM,
wherein the nonlinear feedback control loop is based on characteristics, having a curved nonlinear envelope, that transforms a control signal expressed in terms of maximum number of resource blocks as allowed to be scheduled within the transmission slot, to a corresponding logarithmic domain downlink power reduction, and
wherein the measured uplink PIM is given by, in each transmission slot, probing a radio channel over which the uplink PIM is received; and
apply the set of transmission power reduction factors to the determined fraction of total transmission resources as distributed over a set of downlink, DL, transmission carriers within the transmission slot during transmission of a set of signals in the set of DL transmission carrier.
